(19) United States
(12) Patent Application Publication
(10) Pub. No.: US 2024/0086601 A1
(43) Pub. Date: Mar. 14, 2024

(54) METHOD AND SYSTEM TO GENERATE PERFORMANCE-DATA-LIBRARY ASSOCIATED WITH STANDARD-CELL-LIBRARY

(71) Applicant: TAIWAN SEMICONDUCTOR MANUFACTURING COMPANY, LTD., Hsinchu (TW)

(72) Inventors: Johnny Chiahao LI, Hsinchu (TW); Tzu-Hsuan HO, Hsinchu (TW); Pei-Wei LAO, Hsinchu (TW); Bing-Hsiu WU, Hsinchu (TW); Jerry Chang Jui KAO, Hsinchu (TW)

(21) Appl. No.: 18/158,159

(22) Filed: Jan. 23, 2023

Related U.S. Application Data
(60) Provisional application No. 63/375,412, filed on Sep. 13, 2022.

(51) Int. Cl. G06F 30/33; G06F 30/343

(52) U.S. Cl. CPC G06F 30/33; G06F 30/343

(57) ABSTRACT

A method of generating a first performance-data-library (for a standard-cell-library) includes: for each standard cell that includes multiple gates, sorting the gates into groups including searching for matched ones amongst the gates (matched gates), grouping corresponding matched gates into corresponding multiple member-gates, and (for unmatched ones of the gates having no other matched gate (unmatched gates)), grouping the unmatched gates into corresponding single-member groups; for each standard cell, generating a corresponding first volume of performance data including, for each group, discretely calculating the first volume of performance data, mapping the volume of performance data to the subject gate in the group, and, for each multimember group, mapping the volume of performance data to non-subject gates; and basing the first performance-data-library at least in part on the first volumes of performance data. Such mapping is an example of exploiting redundancies in the performance-data to reduce computational burden.

### PRIORITY CLAIM

The present application claims the priority of U.S. Provisional Application No. 63/375,412, filed Sep. 13, 2022, which is incorporated herein by reference in its entirety.

### BACKGROUND

The integrated circuit (IC) industry produces a variety of analog and digital semiconductor devices to address issues in different areas. Developments in semiconductor process technology nodes have progressively reduced component sizes and tightened spacing resulting in progressively increased transistor density. ICs progressively become smaller.

A layout diagram is used to represent a semiconductor device during the design of the semiconductor device. A designer of a layout diagram selects standard cells from a standard-cell-library and includes the same in the layout diagram. Once included in a layout diagram, the former standard cell is referred to as an instantiation of the standard cell. An instantiated cell differs from a standard cell, e.g., by further including information regarding, e.g., the geometric location of the instantiated cell in the layout diagram, particular signals which are coupled to the inputs of the instantiated cell, the load coupled to the output(s) of the instantiated cell, or the like.

### BRIEF DESCRIPTION OF THE DRAWINGS

One or more embodiments are illustrated by way of example, and not by limitation, in the figures of the accompanying drawings. The drawings are not to scale, unless otherwise disclosed.

FIG. 1A is a block diagram of an electronic design automation (EDA) system, in accordance with some embodiments.

FIG. 1B is a block diagram of performance-data-library generation, in accordance with some embodiments.

FIGS. 2A-2C are block diagrams of corresponding standard cells, in accordance with some embodiments.

FIGS. 3A-3C are block diagrams of standard cell, in accordance with some embodiments.

FIG. 3D is a block diagram of a standard cell, in accordance with some embodiments.

FIG. 4A is a data structure of a performance data for a standard cell, in accordance with some embodiments.

FIGS. 4B-4C are representations of corresponding combinations of values on inputs pins, in accordance with some embodiments.

FIG. 4D is a data structure of a performance data for a standard cell, in accordance with some embodiments.

FIGS. 4E-4F are representations of corresponding combinations of values on inputs pins, in accordance with some embodiments.

FIGS. 5A-5F are corresponding data structures for performance data, in accordance with some embodiments.

FIGS. 5G-5N are corresponding data structures for performance data, in accordance with some embodiments.

FIGS. 6A-6D are block diagrams of corresponding multibit flip-flops, in accordance with some embodiments.

FIGS. 6E-6H are block diagrams of corresponding single-bit flip-flops, in accordance with some embodiments.

FIGS. 7A-7C are flow diagrams of corresponding methods of manufacturing a semiconductor device, in accordance with some embodiments.

FIG. 8 is a block diagram of an integrated circuit (IC) manufacturing system, and an IC manufacturing flow associated therewith, in accordance with some embodiments.

### DETAILED DESCRIPTION

The following discloses many different embodiments, or examples, for implementing different features of the subject matter. Examples of components, materials, values, steps, operations, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact, and further include embodiments in which additional features are formed between the first and second features, such that the first and second features are in indirect contact. In addition, the present disclosure repeats reference numerals and/or letters in the various examples. This repetition is for purposes of simplicity of illustration in the figures and reduced repetition of corresponding discussion in the specification; the scope of any relationship imputable from elements-in-common between the various embodiments and/or configurations discussed are informed by looking at contextual differences between common elements and distinct elements in different embodiments. For example, these contextual differences include differences resulting from the function of the distinct elements, differences of interconnection among otherwise-common elements, differences of timing relationships for otherwise-common elements, the resulting changes in interconnections and timing relationships in the otherwise-common elements because of the operation of the distinct elements, and/or the like

Further, spatially relative terms, such as “beneath,” “below,” “lower,” “above,” “upper” or the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein are likewise interpreted accordingly. In some embodiments, the term standard cell structure refers to a standardized building block included in a library of various standard cell structures (standard-cell-library). In some embodiments, various standard cell structures are selected from a library thereof and are used as components in a layout diagram representing a circuit.

In some embodiments, a method of method of manufacturing a semiconductor device includes generating a first performance-data-library for a corresponding library of standard cells. Such a method (1) reduces the computational-load which generation of the first performance-data-library represents and (2) reduces the file-size of a file containing the first performance-data-library by exploiting redundancies in the first performance-data.

In general, standard cells are used in the design of an intended semiconductor device. Here, i.e., at the beginning of this paragraph, reference to the semiconductor device is modified using the adjective ‘intended’ which draws a contrast to a reference to the semiconductor device in this paragraph which is modified using the label ‘actual.’ Typically, at the beginning of the design of the intended semiconductor device, functional and operational requirements of the intended semiconductor device are drafted. Then a circuit diagram of the intended semiconductor device is designed which satisfies the functional and operational requirements. Then a layout diagram is designed which represents the circuit diagram. The layout diagram includes instantiated cells, each instantiated cell being an instantiation of a corresponding standard cell selected from a standard-cell-library of standard cells. The standard-cell-library corresponds to the semiconductor process technology node by which the intended semiconductor device will be manufactured. Then the layout diagram is subjected to various verification processes which confirm, among other things, that an actual semiconductor based on the layout diagram will satisfy all functional and operational requirements of the intended semiconductor device. One or more of the various verification processes rely upon, among other things, attributes of the instantiated cells. The attributes of the instantiated cells are based on the attributes of the corresponding standard cells. Attributes of the standard cells are based on one or more corresponding performance-data-libraries.

According to another approach, redundancies in performance-data are not recognized, rather each performance-data-library is discretely calculated by a characterization tool, which is (at the least) computationally burdensome because of the large number of different combinations of values on the input terminals/pins (as explained below) each of which is the subject of a discrete calculation. It is assumed that a standard cell in the standard-cell-library according to the other approach includes a total of M gates, each gate having a total of n input terminals/pins, where each of M and n is a positive integer, 2≤M and 2≤M. Accordingly, a total number of input pins of the given gate according to the other approach is a product of the number of gates and the number of input pins per gate, namely n*M. As an example, it is further assumed that a given performance-data-library according to the other approach contains propagation delay data. The propagation delay library for a given standard cell according to the other approach provides propagation delay values for each gate in the given standard cell, and more particularly, for each combination of (1) values which are applied to the input pins of the given gate and (2) values which are applied to the input pins of the M−1 other gates in the given standard cell. As such, according to the other approach, the total number of propagation delay values in the propagation delay data-library for the given gate is 2\hat{ }\hat{ }(n*M) which is a large number; and the total number of propagation delay values for the given standard cell is M*2\hat{ }\hat{ }(n*M) which is a yet larger number. It is further assumed that there are L standard cells in the standard-cell-library according to the other approach, where L is a large positive integer; accordingly, the total number of propagation delay values for the propagation delay library according to the other approach is L*(M*2\hat{ }\hat{ }(n*M)), which is a yet larger number.

Because the other approach does not recognize redundancies in performance-data, the other approach must make L*(M*2\hat{ }\hat{ }(n*M)) discrete calculations to generate the propagation delay library corresponding to the standard-cell-library, which is a substantial computational burden in terms of the amount of computational resources consumed by such generation, the time required for such generation, or the like. Consequently, the file-size of the propagation delay library according to the other approach is large, which is a substantial computational burden in terms of being more difficult to transmit electronically, more difficult for a user to keep cached in volatile memory of an electronic design automation (EDA) system, consequently being more slowly accessible by the EDA system (e.g., when executing verification processes), or the like. By contrast, a method of manufacturing a semiconductor device according to at least some embodiments does take into consideration redundancies in performance-data which has benefits including (1) reducing the computational-load which generation of a given performance-data-library represents as compared to the other approach and (2) reducing the file-size of a file containing the first performance-data-library compared to the other approach, or the like.

As part of developing embodiments of the present application, the inventors recognized that performance data libraries corresponding to a standard-cell-library contain, for a given standard cell, a substantial amount of redundancy; and that such redundancy presents opportunities to reduce the computational burden which generation of a given performance-data-library represents. At least some embodiments take into consideration redundancies in performance-data when generating a first performance-data-library for a corresponding library of standard cells by recognizing that performance-data, for a given one of the standard cells, is more dependent upon (A) the values which are applied to the input pins of the given gate and less dependent upon (B) the values which are applied to the input pins of the M−1 other gates.

Assuming that each standard cell has M gates of which each gate has n input terminals/pins, for a given one of the 2\hat{ }\hat{ }(n*M) combinations of (1) the values which are applied to the input pins of the given gate and (2) the values which are applied to the input pins of the M−1 other gates in the given standard cell, a large majority, namely 2\hat{ }\hat{ }(n*(M−1)), of the total combinations are attributable (due) to (2) the subcombinations of values which are applied to the input pins of the M−1 other gates in the given standard cell. However, having recognized that performance-data is more dependent upon (A) the values which are applied to the input pins of the given gate and less dependent upon (B) the values which are applied to the input pins of the M−1 other gates, at least some embodiments represent at least in part a further recognition by the inventors that the contributions to the discrete calculations of performance data by all but a few, e.g., one, of the 2\hat{ }\hat{ }(n*(M−1)) combinations attributable to the values which are applied to the input pins of the M−1 other gates are negligible, i.e., result in redundant performance data.

Accordingly, at least some embodiments exploit redundancies in performance-data by focusing on the contribution to the discrete calculations of performance data by the 2\hat{ }\hat{ }n contributions of (1) the values which are applied to the input pins of the given gate and (2) the contribution of the few ones amongst the 2\hat{ }\hat{ }(n*(M−1)) combinations of values attributable to the input pins of the M−1 other gates. The few ones amongst the 2\hat{ }\hat{ }(n*(M−1)) combinations of values attributable to the input pins of the M−1 other gates are represented by a variable J which is a positive integer that typically is less than n, i.e., J<n. In some embodiments, J=1. In some embodiments, exploitation of the performance data redundancy results in making J*2\hat{ }\hat{ }n discrete calculations of performance data for the given gate. The J*2\hat{ }\hat{ }n discrete calculations made by such embodiments is substantially fewer calculations than the 2\hat{ }\hat{ }(n*M) discrete calculations of performance data that would otherwise be made for the given gate according to the other approach. In such embodiments, exploitation of the performance data redundancy results in making A fewer discrete calculations for the given gate, where Δ=2\hat{ }\hat{ }(n*m)−J*2\hat{ }\hat{ }n. As compared to the 2\hat{ }\hat{ }(n*(m−1)) discrete calculations of performance data made by the other approach for the given gate, such embodiments of the present application which make J*2\hat{ }\hat{ }n discrete calculations of performance data for the given gate beneficially exhibit an M orders reduction of base-two-magnitude in the number of discrete calculations being made, which is a substantial reduction and thus represents a substantial reduction in computation burden upon the EDA system.

In some embodiments, each standard cell includes one or more gates. In some embodiments, at least some of the gates in a standard cell are combinational logic (logic gates). In some embodiments, —at least some of the gates in a standard cell are asynchronous logic (flip-flop gates).

In some embodiments, a method of manufacturing a semiconductor device includes, for each standard cell in a standard-cell-library, generating a first performance-data-library including: sorting the gates into multimember groups and single-member groups; on a group-by-group basis, generating a corresponding first volume of performance data including mapping within multimember groups; and bundling. For each standard cell that includes multiple gates, the sorting includes: sorting the gates into groups including searching on a gatewise basis for matched ones amongst the gates (matched gates); grouping corresponding matched gates into corresponding first groups, each first group having multiple member-gates; and, for unmatched ones of the gates having no other matched gate (unmatched gates), grouping the unmatched gates into corresponding second groups, each second group having a corresponding single member-gate. For each standard cell, and for each first group, the generating a first performance-data-library further includes generating a corresponding first volume of performance data including: for a subject one of the member-gates in the first group (first subject gate), discretely calculating the first volume of performance data; and mapping the volume of performance data to the first subject gate; and mapping the first volume of performance data to remaining ones of the member-gates in the first group (non-subject gates). Such mapping is an example of exploiting redundancies in the first performance-data. For each standard cell, and for each second group, the generating a first performance-data-library further includes generating a corresponding first volume of performance data including: for a subject one of the member-gates in the second group (second subject gate), determining the first volume of performance data; and mapping the first volume of performance data to the second subject gate of the second group, i.e., to the sole member member-gate of the second group. In some embodiments, the bundling includes bundling the first volumes of performance data to form the first performance-data-library.

In some embodiments, a method of manufacturing a semiconductor device includes, for each standard cell in a standard-cell-library, generating a first performance-data-library including: sorting features of the gates into multi-member groups and single-member groups; on a group-by-group basis, generating a corresponding first volume of performance data including mapping within multimember groups; and bundling. For each standard cell that includes multiple gates, the sorting includes: searching on a featurewise basis for matched ones amongst the features of the gates (matched features); grouping corresponding matched features into corresponding first groups, each first group having multiple member-features; and for unmatched ones of the features having no other matched feature (unmatched features), grouping the unmatched features into corresponding second groups, each second group having a corresponding single member-features. For each standard cell, and for each first group, the generating a first performance-data-library further includes generating a corresponding first volume of performance data including: for a subject one of the member-features in the first group (first subject feature), discretely calculating the first volume of performance data; mapping the volume of performance data to the first subject feature; and mapping the first volume of performance data to remaining ones of the member-features in the first group (non-subject features). Such mapping is an example of exploiting redundancies in the first performance-data. For each standard cell, and for each second group, the generating a first performance-data-library further includes generating a corresponding first volume of performance data including: for a subject one of the member-features in the second group (second subject feature), determining the first volume of performance data; and mapping the first volume of performance data to the second subject feature, i.e., to the sole member-feature of the second group. In some embodiments, he bundling includes bundling the first volumes of performance data to form the first performance-data-library.

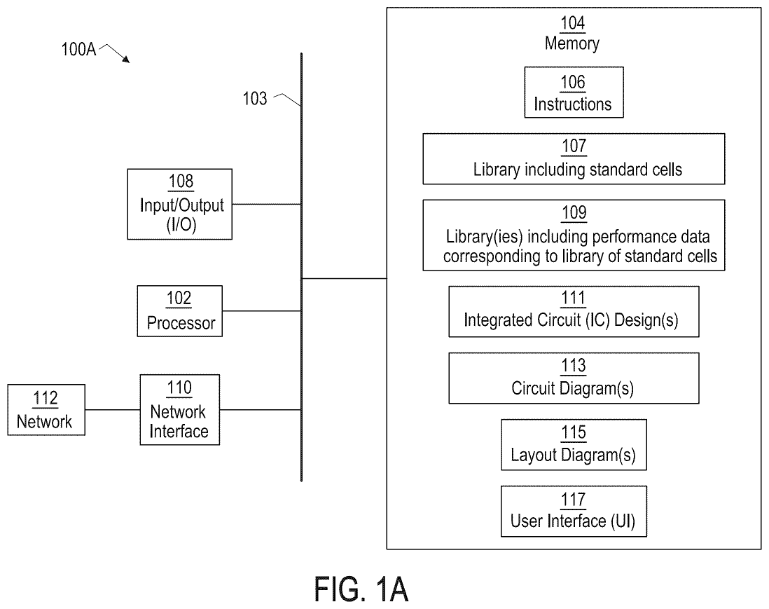

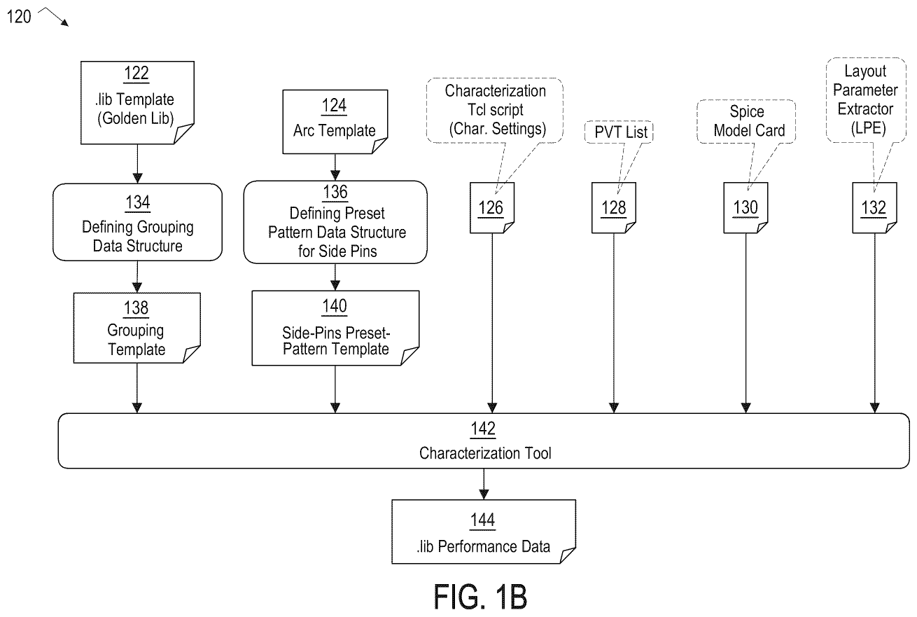

FIG. 1A is a block diagram of an electronic design automation (EDA) system 100A in accordance with some embodiments.

Methods disclosed herein include methods (see below) for generating a performance-data-library for a standard-cell-library. At least some of the methods disclosed herein, e.g., at least some of the flowcharts disclosed herein, are implemented, for example, using EDA system 100A, in accordance with some embodiments.

In some embodiments, EDA system 100 includes an APR system. In some embodiments, EDA system 100 is a general purpose computing device including a hardware processor 102 and a non-transitory, computer-readable storage medium 104. Storage medium 104, amongst other things, is encoded with, i.e., stores, computer program code 106, i.e., a set of executable instructions. Execution of instructions 106 by hardware processor 102 represents (at least in part) an EDA tool which implements a portion or all of, e.g., the methods disclosed herein, or the like, in accordance with one or more embodiments (hereinafter, the noted processes and/or methods). Storage medium 104, amongst other things, stores files including: a library 107 of standard cells; one or more libraries 109 of performance data corresponding to the standard cells of library 107, e.g., some or all of the performance data libraries disclosed herein, or the like; one or more integrated circuit (IC) designs 111 including functional and/or operational requirements of the IC designs; one or more circuit diagrams 113; one or more layout diagrams 115; and a user interface 117.

Processor 102 is electrically coupled to computer-readable storage medium 104 via a bus 103. Processor 102 is further electrically coupled to an I/O interface 108 by bus 103. A network interface 110 is further electrically connected to processor 102 via bus 103. Network interface 110 is connected to a network 112, so that processor 102 and computer-readable storage medium 104 are capable of connecting to external elements via network 112. Processor 102 is configured to execute computer program code 106 encoded in computer-readable storage medium 104 in order to cause system 100 to be usable for performing a portion or all of the noted processes and/or methods. In one or more embodiments, processor 102 is a central processing unit (CPU), a multi-processor, a distributed processing system, an application specific integrated circuit (ASIC), and/or a suitable processing unit.

In one or more embodiments, computer-readable storage medium 104 is an electronic, magnetic, optical, electromagnetic, infrared, and/or a semiconductor system (or apparatus or device). For example, computer-readable storage medium 104 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 104 includes a compact disk-read only memory (CD-ROM), a compact disk-read/write (CD-R/W), and/or a digital video disc (DVD).

In one or more embodiments, storage medium 104 stores computer program code 106 configured to cause system 100A (where such execution represents (at least in part) the EDA tool) to be usable for performing a portion or all of the noted processes and/or methods. In one or more embodiments, storage medium 104 further stores information which facilitates performing a portion or all of the noted processes and/or methods.

EDA system 100 includes I/O interface 108 which is coupled to external circuitry. In one or more embodiments, I/O interface 108 includes a keyboard, keypad, mouse, trackball, trackpad, touchscreen, and/or cursor direction keys for communicating information and commands to processor 102.

EDA system 100 further includes network interface 110 coupled to processor 102. Network interface 110 allows system 100 to communicate with network 112, to which one or more other computer systems are connected. Network interface 110 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more systems 100.

System 100 is configured to receive information through I/O interface 108. The information received through I/O interface 108 includes one or more of instructions, data, design rules, libraries of standard cells, and/or other parameters for processing by processor 102. The information is transferred to processor 102 via bus 103. EDA system 100 is configured to receive information related to a UI through I/O interface 108. The information is stored in computer-readable medium 104 as user interface (UI) 117.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by EDA system 100. In some embodiments, a layout which includes standard cells is generated using a tool such as VIRTUOSO® available from CADENCE DESIGN SYSTEMS, Inc., or another suitable layout generating tool.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

FIG. 1B is a data flow diagram 120 of performance-data-library generation, in accordance with some embodiments.

In data flow diagram 120, various information (discussed below) is provided to a characterization tool 142 which generates a performance-data-library 144 for a corresponding library of standard cells. In contrast to a counterpart characterization tool according to the other approach which does not takes into consideration redundancies in performance-data, characterization tool 142 does take into consideration redundancies in performance-data (discussed below). Characterization tool 142 exploits redundancies in performance-data which has benefits including (1) reducing the computational-load which generation of a given performance-data-library represents as compared to the other approach (discussed above) and (2) reducing the file-size of a file containing the first performance-data-library compared to the other approach, or the like.

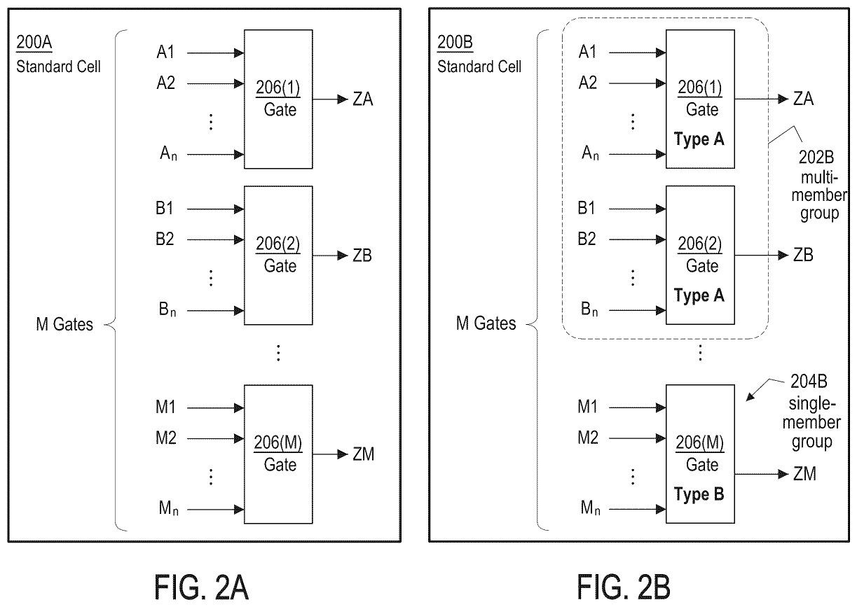

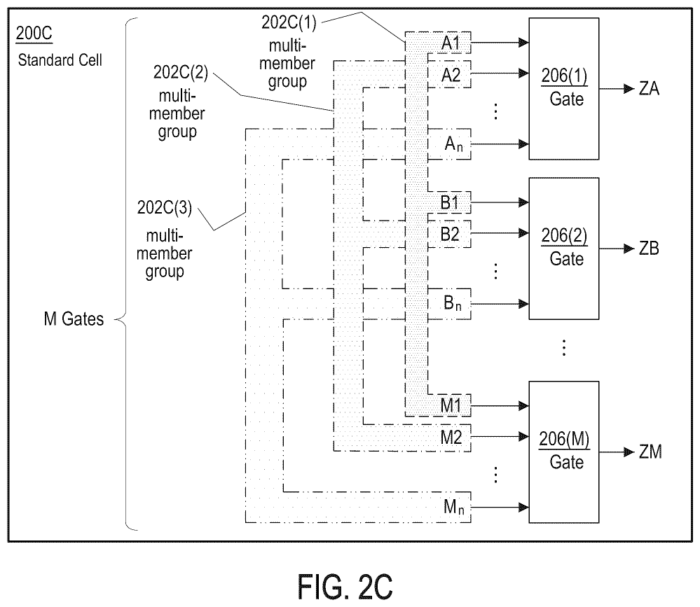

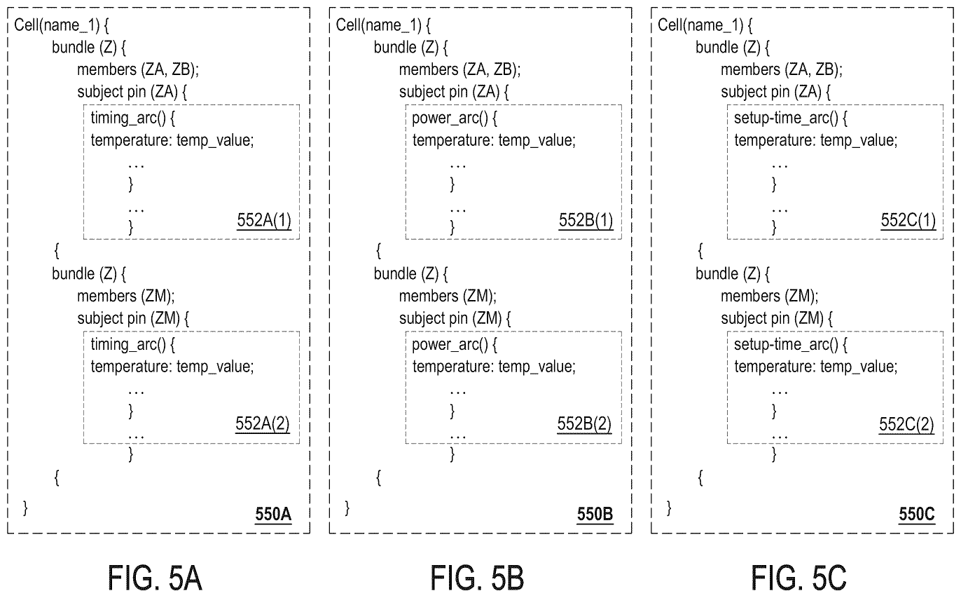

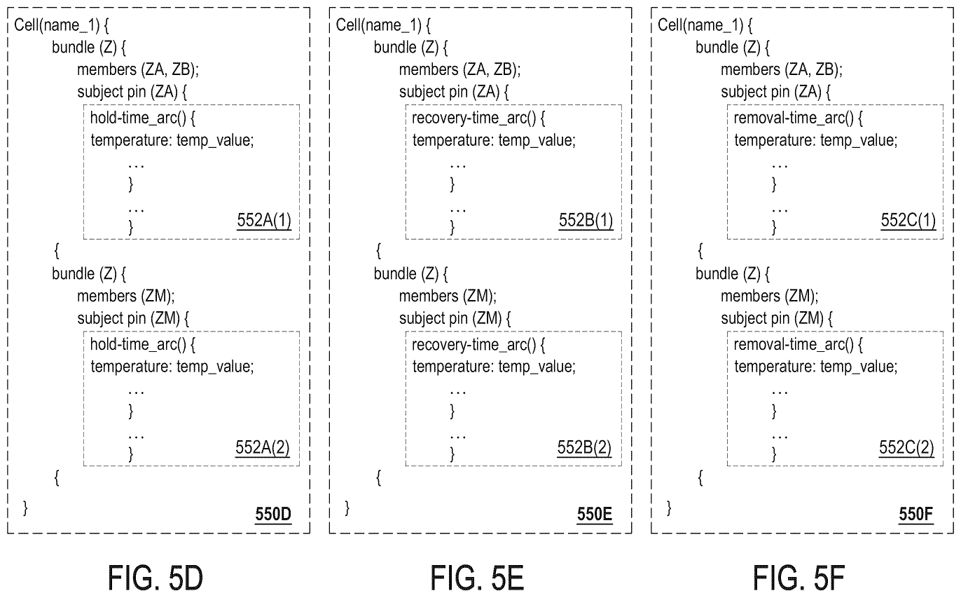

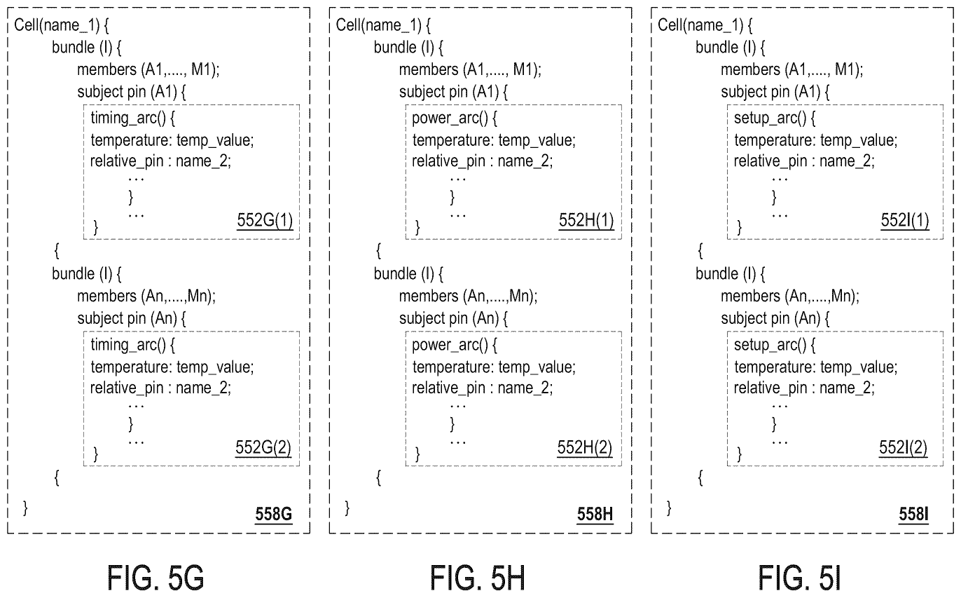

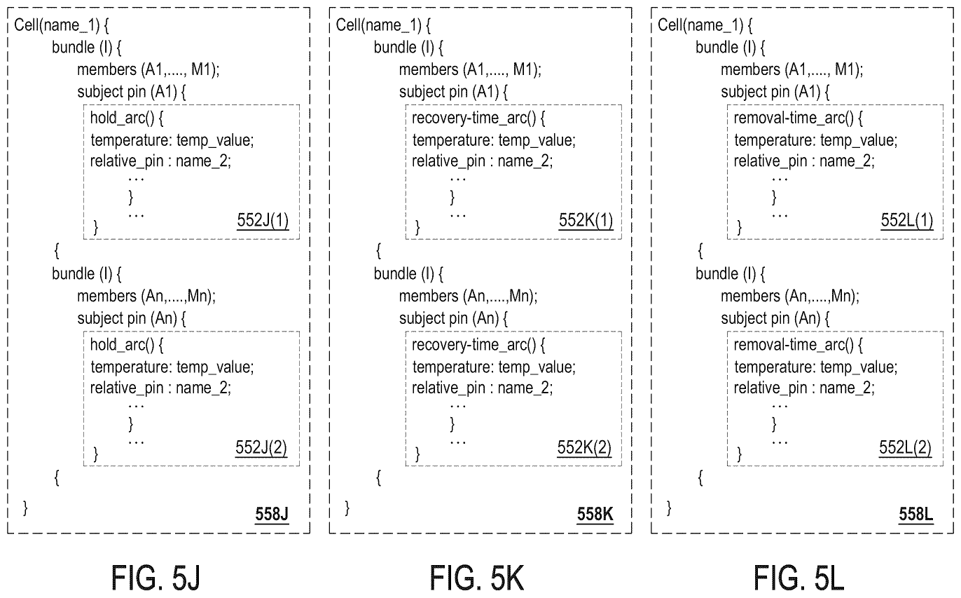

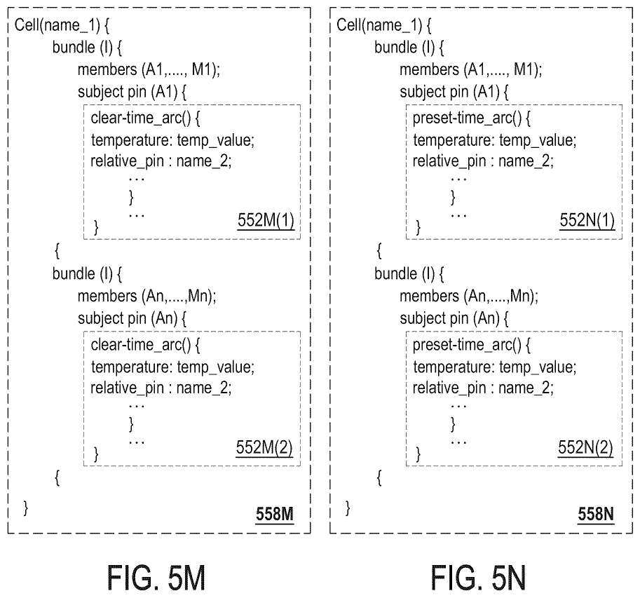

For purposes of discussion, it is assumed that each standard cell includes a total of M gates (FIG. 2A), each gate having a total of n input terminals/pins (FIG. 2A), where each of M and n is a positive integer, 2≤M and 2≤M, and that there are L standard cells in the standard-cell-library, where L is a large positive integer. To generate a given performance-data-library (e.g., a propagation delay library) corresponding to a standard-cell-library, for each of the M gates in each standard cell, i.e., for a given gate in a given standard cell, characterization tool 142 makes one determination of the performance data for each of a total of M*2\hat{ }\hat{ }(n*M) combinations of input values which are applied (1) to the input terminals/pins of a given gate in the given standard cell and (2) to the input terminals/pins of the M−1 other gates in the given standard cell. However, it is to be understood that such determination by characterization tool 142 not only includes making a discrete calculation of performance data but further includes making a mapping of previously discretely-calculated performance data instead of making a discrete calculations of otherwise redundant performance data. The sorting of matched gates (FIGS. 2B-2C and 5A-5N) into groups, or of features of gates into groups, is what facilitates such mapping.

In the context of characterization of a given standard cell, and further within the context of a given group of two or more matched gates (FIGS. 2B-2C and 5A-5N) in the given standard cell, it is much less computationally burdensome for characterization tool 142 to make a mapping of performance data that was previously discretely-calculated for the subject member of the given group to non-subject members of the given group than it is for characterization tool 142 to make a discrete calculation of otherwise redundant performance data for each of the non-subject members of the given group. Such mapping is an example of exploiting redundancies in the first performance-data.

More particularly, it is to be recalled that the inventors have recognized that the contributions to the discrete calculations of performance data by all but a few ones amongst the 2\hat{ }\hat{ }(n*(M−1)) combinations attributable to the values which are applied to the input pins of the M−1 other gates are negligible, i.e., result in redundant performance data. In light of the inventors' recognition, characterization tool 142 exploits the redundancy in the performance data attributable to the values which are applied to the input pins of the M−1 other gates by representing the 2\hat{ }\hat{ }(n*(M−1)) combinations of values attributable to the values which are applied to the input pins of the M−1 gates using a few ones amongst the 2\hat{ }\hat{ }(n*(M−1)) combinations of values attributable to the input pins of the M−1 other gates. The few ones amongst the 2\hat{ }\hat{ }(n*(M−1)) combinations of values attributable to the input pins of the M−1 other gates are represented by J, where typically J<n. In some embodiments, J=1. Accordingly, for the given gate, characterization tool 142 makes one discrete calculation of a performance datum for each of the total of 2\hat{ }\hat{ }(n*M) combinations of input values which are applied (1) to the input terminals/pins of a given gate and (2) to the few ones amongst the 2\hat{ }\hat{ }(n*(M−1)) combinations of values attributable to the input pins of the M−1 other gates in the given standard cell. As a result, characterization tool 142 makes J*2\hat{ }\hat{ }n discrete calculations of performance data for the given gate. The characterization tool 142 making J*2\hat{ }\hat{ }n discrete calculations of performance data for the given gate, which is substantially fewer calculations than the 2\hat{ }\hat{ }(n*M) discrete calculations of performance data that would otherwise be made for the given gate according to the other approach. In such embodiments, exploitation of the performance data redundancy by characterization tool 142 results in making A fewer discrete calculations for the given gate, where Δ=2\hat{ }\hat{ }(n*M)−J*2\hat{ }\hat{ }n. As compared to the 2\hat{ }\hat{ }(n*(M 1)) discrete calculations of performance data made by the other approach for the given gate, such embodiments of the present application which make J*2\hat{ }\hat{ }n discrete calculations of performance data for the given gate beneficially exhibit an M orders reduction of base-two-magnitude in the number of discrete calculations being made, which is a substantial reduction and thus represents a substantial reduction in computation burden upon the EDA system.

In FIG. 1B, the various information provided to characterization tool 142 includes: a grouping template 138; a 140 of preset side-pin values (side-pins preset-pattern); a characterization tool command language (Tcl) script 126 of characterization settings; list of a process, voltage and temperature (PVT) parameters (PVT list) 128; a SPICE Model Card 130; and a layout parameter extractor file 132. Each of characterization Tcl script 126, PVT list 128, SPICE Model Card 130 and layout parameter extractor file 132 is an example of information provided conventionally to characterization tool 142. By contrast, embodiments of the present application additionally provide grouping template 138 and preset pattern of side-pin values template 140 to characterization tool 142, which is a reflection, in part, of data flow 120 taking into consideration redundancies in performance-data when generating performance-data-library 144.

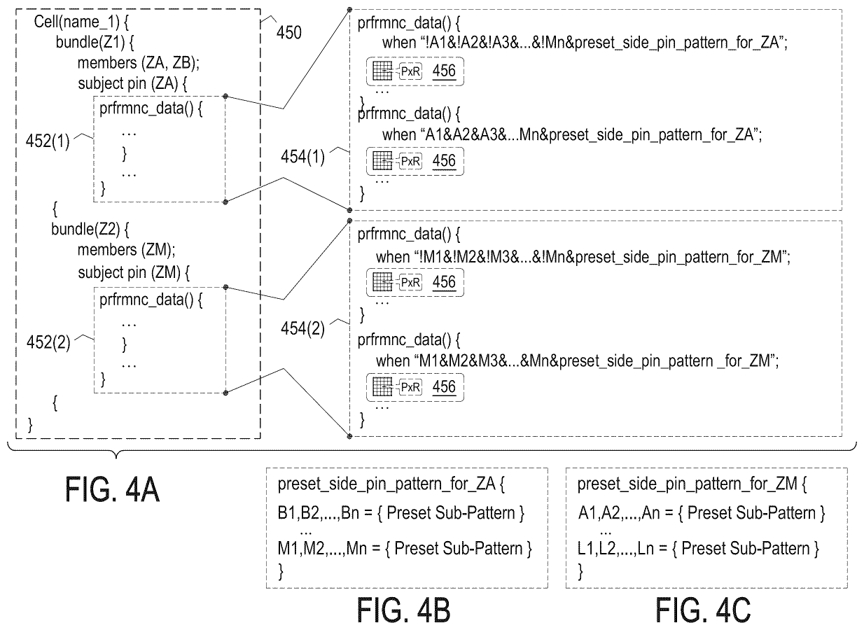

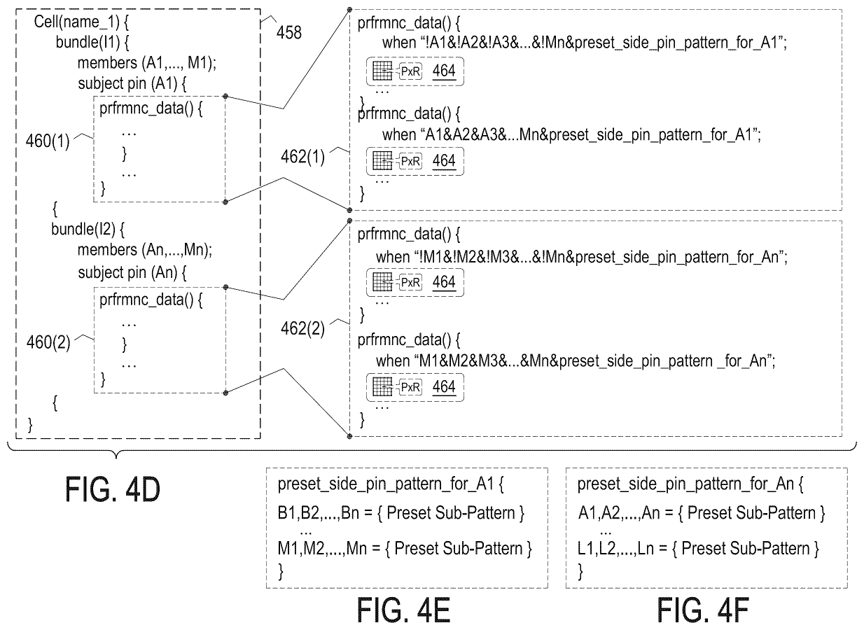

In FIG. 1B, group template 138 (FIG. 4A, 4D, 5A-5N, or the like) is generated by a process 134 which operates on a golden library template 122. Process 134 defines a grouping data structure which is reflected in grouping template 138. Golden library template 122 is an example of information conventionally provided directly to the characterization tool according to the other approach.

Preset pattern of side-pin values template 140 (FIG. 4B-4C, 4E-4F, or the like) is generated by a process 136 which operates on an arc template 124. In some embodiments, regarding item 140 of FIG. 1B, the use of the adjective ‘side’ to modify the phrase ‘pins preset-pattern template’ is intended to connote that the values on the input pins of the M−1 gates other than the given gate (M−1 other gates) do not influence the logical value on the output terminal/pin of the given gate. In such embodiments, furthermore, the use of the adjective ‘side’ to modify the phrase ‘pins preset-pattern template’ is intended to connote that the contributions to the discrete calculations of performance data by all but a few, e.g., one, of the input pins of the M−1 gates other than the given gate (M−1 other gates) to the calculation of performance data for the n input pins of the given cell in a standard cell are negligible (FIG. 2B).

In some embodiments, an arc is another term for a performance datum corresponding to a given one of the total of 2\hat{ }\hat{ }(n*M) combinations of input values which are applied (1) to the input terminals/pins of a given gate in a given standard cell and (2) to the input terminals/pins of the M−1 other gates in the given standard cell. Arc template 124 is an example of information conventionally provided directly to the characterization tool according to the other approach.

FIGS. 2A-2C are block diagrams of corresponding standard cells 200A-200C, in accordance with some embodiments.

In FIGS. 2A-2C, each of standard cells 200A-200C includes gates 206(1), 206(2), . . . , 206(M−1) (not shown) and 206(M), i.e., a total of M gates. Each of gates 206(1)-206(M) has a total of n input terminals/pins. Each of M and n is a positive integer, 2≤M and 2≤M. In some embodiments, one or more but not all of gates 306(1)-306(M) has a number of pins other than n pins.

Gate 206(1) has input terminals/pins A1, A2, . . . , A(n−1) (not shown) and An, and an output terminal pin ZA. Gate 206(2) has input terminals/pins B1, B2, . . . , B(n−1) (not shown) and Bn, and an output terminal pin ZB. Gate 206(M) has input terminals/pins M1, M2, . . . , M(n−1) (not shown) and Mn, and an output terminal pin ZM. In some embodiments, each of gates 206(1)-206(M) includes a second output pin.

In FIG. 2B, standard cell 200B has not yet been subjected to grouping according to various embodiments disclosed herein (FIGS. 2B-2C), or the like. By contrast, in FIGS. 2B-2C, corresponding standard cells 200B-200C have been subjected to grouping according to various embodiments disclosed herein.

In FIG. 2B, standard cell 200B been subjected to grouping according to various embodiments disclosed herein. More particularly, gates 206(1)-206(M) are sorted on a gatewise basis for matched ones amongst the gates (matched gates). In some embodiments, sorting on a gatewise basis means sorting according to attributes of the gate as a whole. For example, an attribute of a logical gate as a whole is the logical function performed by the logical gate, NOT, AND, OR, XOR, NOT, NAND, NOR, XNOR, AND-OR-Inverter (AOI), OR-AND-Inverter (OAI), or the like. For example, an attribute of a flip-flop gate as a whole is the type of storage function performed by the flip-flop gate, e.g., set-reset (SR) flip-flop, JK flip-flop, data/delay (D) flip-flop, toggle (T) flip-flop, any such flip-flops which further include preset and clear input pins, or the like. In FIG. 2B, the attribute of the gate as a whole on which is based the sorting and matching is gate-type. In some embodiments, gate-type refers to the function performed by the gate (FIG. 2B, or the like).

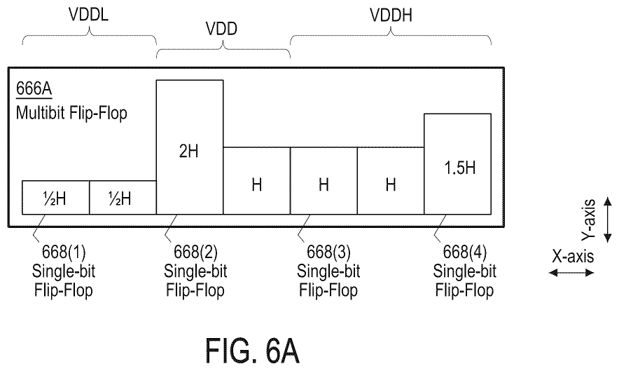

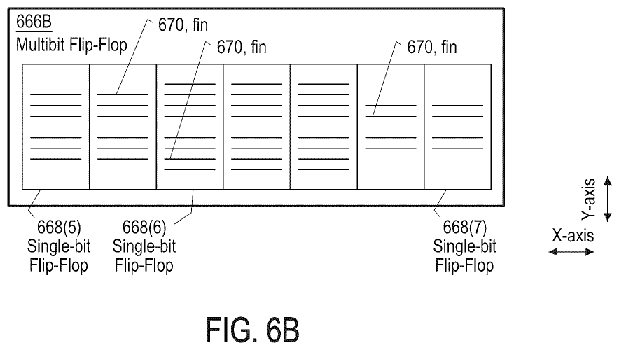

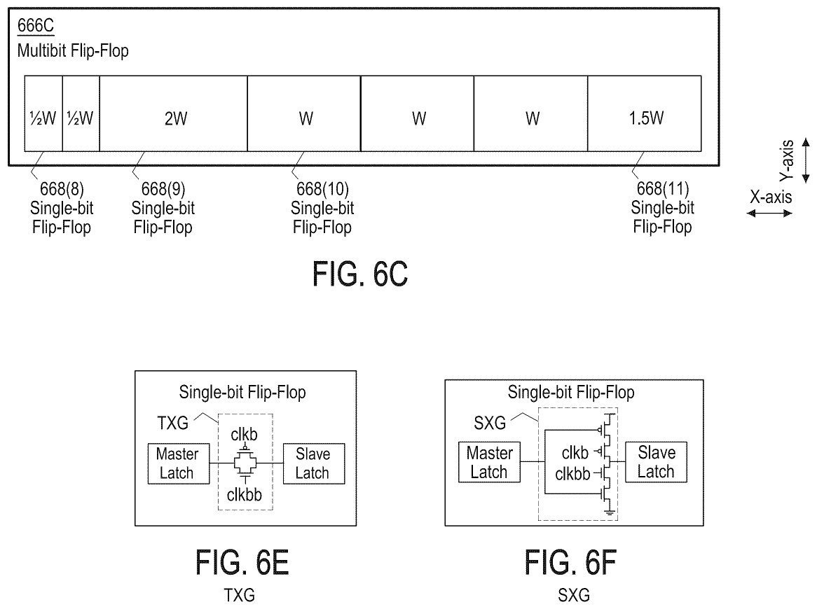

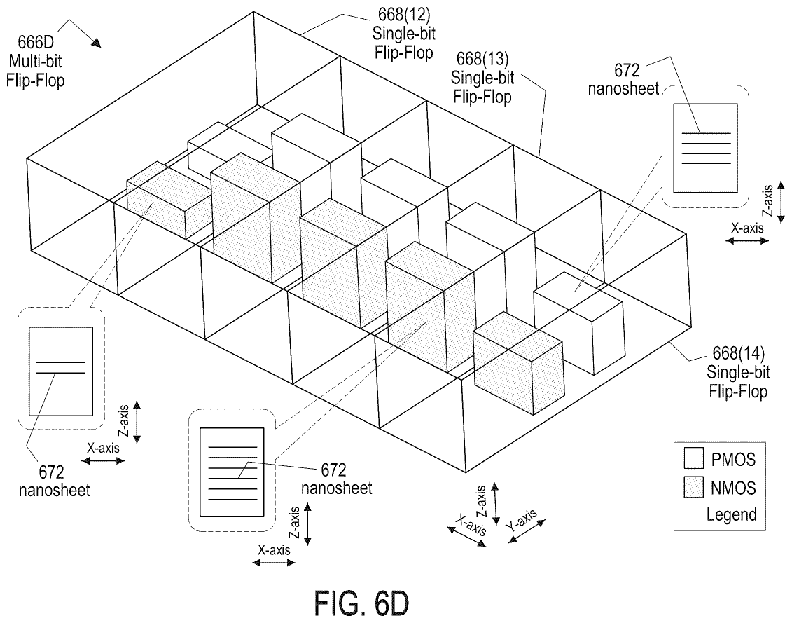

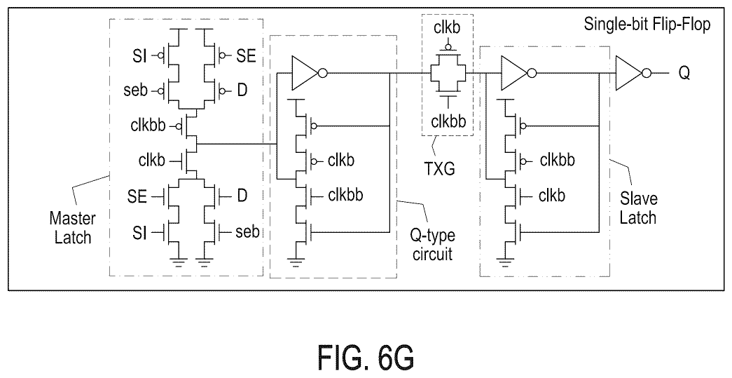

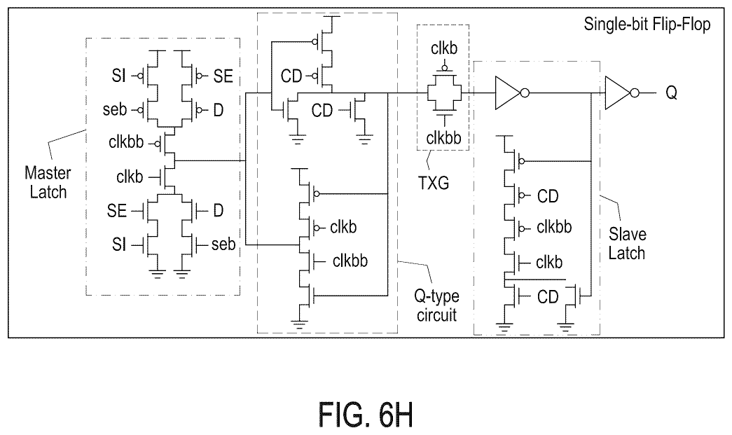

In some embodiments, gate-type refers to a current-driving capability at the output pin of the gate. In some embodiments, gate-type refers to a threshold voltage of transistors in the gate. In some embodiments, gate-type refers to a power domain in which the gate operates. In some embodiments, gate-type refers to the height of the gate relative to the Y-axis (FIG. 6A, or the like). In some embodiments, gate-type refers to the number of fins in the gate (FIG. 6B, or the like). In some embodiments, gate-type refers the width of the gate relative to the X-axis (FIG. 6C, or the like). In some embodiments, gate-type refers to the number of nanosheets in each of the PMOS and NMOS active regions of the gate (FIG. 6D, or the like). In some embodiments, gate-type refers to the circuit topology of the gate, e.g., transmission gate topology (FIG. 6E, or the like) versus stack-gate topology (FIG. 6F, or the like). In some embodiments, in a context of transmission gate topology, gate-type refers to the sub-circuit topology of Q-type coupler (FIG. 6G, or the like) versus RPQ-type coupler (FIG. 6H, or the like), or the like.

In FIG. 2B, matched gates are grouped into corresponding first groups 202B, each first group 202B having multiple member-gates (multimember group). For unmatched ones of the gates having no other matched gate (unmatched gates), the unmatched gates are grouped into corresponding second groups 204B, each second group 204B having a corresponding single member-gate (single member group). For simplicity of illustration, a single instance of first group 202B is shown corresponding to a Type A gate. Also for simplicity of illustration, a single instance of second group 204B is shown corresponding to a Type B gate.

In FIG. 2C, standard cell 200C been subjected to grouping according to various embodiments disclosed herein. More particularly, gates 206(1)-206(M) are sorted on a featurewise basis for matched ones amongst features of the gates (matched features). In some embodiments, sorting on a featurewise basis means sorting according to attributes of the individual input pins, i.e., each input pin resents a features of the given gate. For example, where at least some gates of a standard cell are flip-flop gates, the flip-flop gates are sorted one the basis of the input pin type. In FIG. 2C, the attribute of the gate on which is based the sorting and matching is feature-type. In some embodiments, feature-type refers to input pins, i.e., each input pin of a given gate represents a feature of the given gate.

In FIG. 2C, matched features are grouped into corresponding first groups 202C(1), 202C(2), 202C(3), or the like, each of first groups 202C(1)-202C(2) having multiple member-features. For unmatched ones of the features having no other matched feature (unmatched features), the unmatched features are grouped into corresponding second groups (not shown), each second group having a corresponding single member-feature. For simplicity of illustration, three instances 202C(1)-202C(3) of the first group are shown corresponding to input 1, input pin 2 and input pin n.

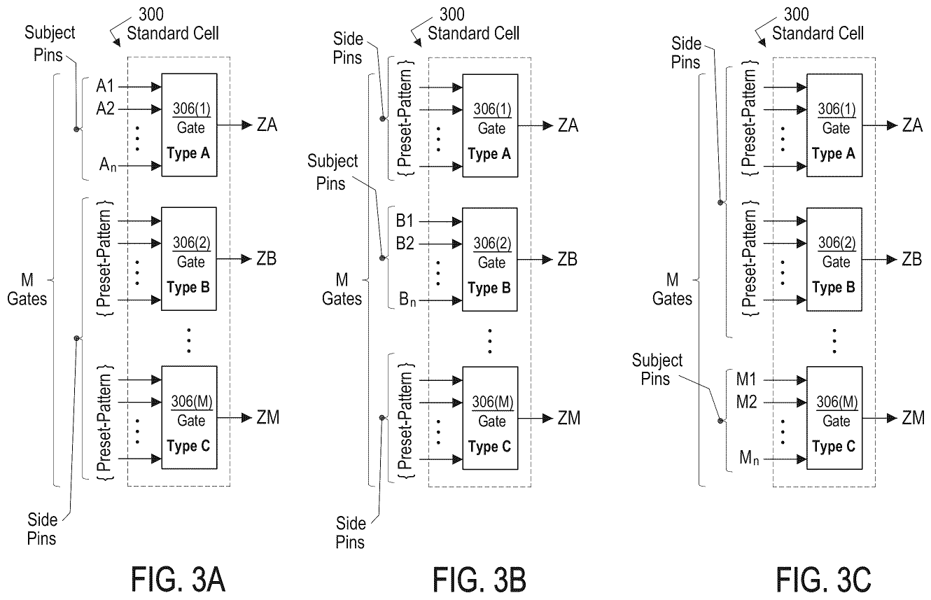

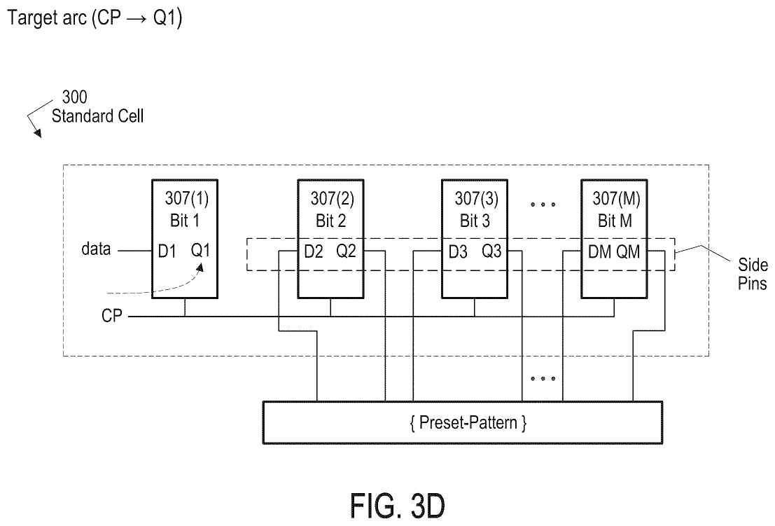

FIGS. 3A-3C are block diagrams of standard cell 300, in accordance with some embodiments.

FIGS. 3A-3C are similar to FIG. 2B. Each of FIGS. 3A-3C shows standard cell 300 albeit with different combinations of input values being applied to gates 306(1), 306(2), . . . , and 306(M). Each of gates 306(1)-306(M) has n input terminals/pins. In some embodiments, one or more but not all of gates 306(1)-306(M) has a number of pins other than n pins. As with FIG. 2B, FIGS. 3A-3C assume that standard cell 300 is being subjected to grouping on a gatewise basis according to various embodiments disclosed herein.

In FIGS. 3A-3C, the attribute of the gate as a whole on which is based the sorting and matching is gate-type. In some embodiments, gate-type refers to the function performed by the gate.

Gate 306(1) is a Type A gate. Gate 306(2) is a Type B gate. Gate 306(3) is a Type C gate. At least one of gates 306(1)-306(3) is a member of a multimember group which includes ones (not shown) of the M gates other than gates 306(1)-306(3). It is assumed that each of gates 306(1)-306(3) is the representative member (subject gate) of its corresponding group of one or more gates.

FIG. 3A represents combinations of input values being applied to gates 306(1), 306(2), . . . , and 306(M) when a corresponding first volume of performance data is being discretely calculated for gate 306(1), where (again) gate 306(1) is the representative gate of the group of which it is a member. In a context in which the group is a multimember group, the first volume of performance data discretely calculated for gate 306(1) is mapped to gate 306(1) as the representative gate and also is mapped to remaining ones of the member-gates (not shown), i.e., the non-representative gates, in the first group. Such mapping is an example of exploiting redundancies in the performance-data.

More particularly, it is to be recalled that characterization tool 142 exploits the redundancy in the performance data attributable to the values which are applied to the input pins of the M−1 other gates by representing the 2\hat{ }\hat{ }(n*(M−1)) combinations of values attributable to the values which are applied to the input pins of the M−1 gates instead with J representative ones amongst the 2\hat{ }\hat{ }(n*(M−1)) combinations, where typically J<n. In FIG. 3A, and likewise in FIGS. 3B-3C, it is assumed that J=1. Accordingly, in FIG. 3A, the input pins of non-subject gates 306(2), . . . , 306(M), receive a preset-pattern (FIGS. 4B-4C) of values.

FIG. 3B represents combinations of input values being applied to gates 306(1), 306(2), . . . , and 306(M) when a corresponding first volume of performance data is being discretely calculated for gate 306(2), where gate 306(2) is the representative gate of the group of which it is a member. In a context in which the group is a multimember group, the first volume of performance data discretely calculated for gate 306(2) is mapped to gate 306(2) as the representative gate and also is mapped to remaining ones of the member-gates (not shown), i.e., the non-representative gates, in the first group. Such mapping is an example of exploiting redundancies in the performance-data. Also in FIG. 3B, the input pins of non-subject gates 306(1) and 306(3) (not shown), . . . , 306(M), receive a preset-pattern (FIGS. 4B-4C) of values.

FIG. 3C represents combinations of input values being applied to gates 306(1), 306(2), . . . , and 306(M) when a corresponding first volume of performance data is being discretely calculated for gate 306(M), where gate 306(M) is the representative gate of the group of which it is a member. In a context in which the group is a multimember group, the first volume of performance data discretely calculated for gate 306(2) is mapped to gate 306(2) as the representative gate and also is mapped to remaining ones of the member-gates (not shown), i.e., the non-representative gates, in the first group. Such mapping is an example of exploiting redundancies in the performance-data. Also in FIG. 3C, the input pins of non-subject gates 306(1), 306(2), . . . , 306(M−1) (not shown), receive a preset-pattern (FIGS. 4B-4C) of values.

FIG. 3D is a block diagram of a standard cell 301, in accordance with some embodiments.

FIG. 3D is similar to each of FIGS. 2C and 3A. FIG. 3D shows standard cell 301 that includes gates 307(1), 307(2), 307(3), . . . , and 307(M). As with FIG. 2C, FIG. 3D assumes that standard cell 301 is being subjected to grouping on a featurewise basis according to various embodiments disclosed herein. Each of gates 307(1), 307(2), 307(3), . . . , and 307(M) has a clock input to receive clock signal CP.

In FIG. 3A, standard cell 301 is a multibit flip-flop. Each of gates 307(1), 307(2), 307(3), . . . , and 307(M) is a single bit flip-flop such that gates 307(1), 307(2), 307(3), . . . , and 307(M) correspondingly represent bits 1, 2, 3, . . . , M. Gate 307(1) also has a data input pin D1 and a data output pin Q1. Gate 307(2) also has a data input pin D2 and a data output pin Q2. Gate 307(3) also has a data input pin D3 and a data output pin Q3. Gate 307(M) also has a data input pin DM and a data output pin QM.

In FIG. 3D, the attribute of the gate on which is based the sorting and matching is feature-type. In FIG. 3D, it is assumed that feature-type refers to input pins, i.e., input pins D1, D2, D3, . . . , DM represent features of gates 307(1), 307(2), 307(3), . . . , and 307(M) which can be sorted for matches.

In FIG. 3D, it is further assumed that input pins D1, D2, D3 and DM represent different features. In some embodiments, an arc is another term for a performance datum. In FIG. 3D, the arc being calculated is the arc from the input pin that receives clock signal CP to the output pin, e.g., Q1 for gate 307(1). At least one of input pins D1, D2, D3 and DM is a member of a multimember group which includes ones (not shown) of the data input pins of the M gates other than gates 307(2), 307(3) and 307(M). It is assumed that each of input pins D1, D2, D3 and DM is the representative member (subject feature) of its corresponding group of one or more input pins of corresponding gates.

FIG. 3D represents combinations of input values being applied to gates 307(1), 307(2), 307(3), . . . , and 306(M) when a corresponding first volume of performance data is being discretely calculated for the feature represented by input pin D1 of gate 307(1), where input pin D1 of gate 307(1) is the representative feature, and thus gate 307(1) is the representative gate, of the group of which it is a member. In a context in which the group is a multimember group, the first volume of performance data discretely calculated for input pin D1 of gate 307(1) is mapped to input pin D1 of representative gate 307(1) as the representative and also is mapped to remaining ones of the member-features (not shown), i.e., the non-representative gates, in the first group. Such mapping is an example of exploiting redundancies in the performance-data. Also in FIG. 3B, the data input pins of non-subject gates 306(1) and 306(3) (not shown), . . . , 306(M), receive a preset-pattern (FIGS. 4E-4F) of values.

FIG. 4A is a data structure 450 of a performance data for a standard cell, in accordance with some embodiments.

FIGS. 4B-4C are representations of corresponding combinations of values on inputs pins, in accordance with some embodiments.

FIGS. 4A-4C facilitate groupwise sorting and mapping, in accordance with at least some method embodiments disclosed herein.

In FIG. 4A, data structure 450 is an example of a data structure which characterization tool 142 populates with data for a corresponding standard cell in a standard-cell-library as part of generating performance-data-library 144. To generate performance-data-library 144, characterization tool 142 iteratively populates data structure 450 for each of the standard cells in the standard-cell-library.

Data structure 450 includes nested data structures. At a top nesting-level, data structure 450 includes a data structure, Cell(name_1), where name_1 is a variable that identifies the standard cell to which the performance data of data structure 450 pertains.

In FIG. 4A, at a next nesting-level, Cell(name_1) includes one or more grouping data structures, bundle(gate_type), where gate_type is a variable which identifies the gate-type by which members of the group are matched. In FIG. 4A, for simplicity of illustration, data structure 450 shows two instances of bundle(gate_type), namely bundle(Z1) and bundle(Z2). In FIG. 4A, the gates are assumed to be logic gates and the gate-type is assumed to be the logical functions of the logical gates; accordingly, variables Z1 and Z2 identify two different logical functions. As a practical matter, the number of instances of bundle(gate_type) is specific to a given standard cell, and depends on the number of groups identified in the given standard cell.

At a next nesting-level, each of bundle(Z1) and bundle(Z2) includes: a first statement, members (gate_name, . . . ); a second statement, subject pin (pin_name); and a data structure, prfrmnc_data.

In general, the first statement, members (gate_name, . . . ), identifies the one or more members of the group. In FIG. 4A, for simplicity of discussion, bundle(Z1) is shown as multimember group and bundle(Z2) is a single member group. In bundle(Z1), the first instance of the first statement, members (ZA, ZB), identifies the members of the multimember group as the gate having output ZA and the gate having output ZB. In bundle(Z2), the second instance of the first statement, members (ZM), identifies the member of the single member group as the gate having output ZM.

Regarding FIG. 4A, in general, the second statement, subject pin (pin_name), identifies one amongst the group of gates as being the subject gate, i.e., as being the representative gate for which discrete calculations of performance data are to be made. The performance data which is discretely calculated for the subject gate is mapped not only to the subject gate but also is mapped to remaining ones of the gates in the group, i.e., is mapped to the non-subject gates in the group. Such mapping is an example of exploiting redundancies in the performance-data. In bundle(Z1), the first instance of the second statement, subject pin (ZA), identifies the subject gate as ZA. In bundle(Z1), the second instance of the second statement, subject pin (ZM), identifies the subject gate as ZM.

In FIG. 4A, the instance of the data structure, prfrmnc_data, in bundle(Z1) is labeled with reference number 452(1), and the instance of the data structure, prfrmnc_data, in bundle(Z2) is labeled with reference number 452(2). Each of prfrmnc_data 452(1)-452(1) is an array containing J*2\hat{ }\hat{ }n performance data values corresponding to the J*2\hat{ }\hat{ }n combinations attributable to the values which are applied to the n input pins of the subject gate and the few ones amongst the 2\hat{ }\hat{ }(n*(M−1)) combinations of values attributable to the input pins of the M−1 other gates. For simplicity of illustration, FIG. 4A assumes that J=1. Prfrmnc_data 452(1) has an exploded view 454(1). Prfrmnc_data 452(2) has an exploded view 454(2).

In exploded view 454(1), the when-statements associated with the entries in array prfrmnc_data 452(1), i.e., the when-statements associated with the performance data values in array prfrmnc_data 452(1), identify the combinations of input values that produced the corresponding entries. In other words, each performance data value in array prfrmnc_data 452(1) has a when-statement which indicates the combination of values of input pins for the subject gate to which the performance data value corresponds (causal combination).

It is noted that FIG. 4A, and FIG. 4D as well, adopts a notation convention in which a logical low (logical zero) value of an input pin is denoted by a text string in which an exclamation point precedes the input pin designation. For example, the text string, !A1, indicates that the value of input pin A1 is logical low (logical zero), i.e., A1=0. Conversely, according to the notation convention, a logical high (logical one) value of an input pin is denoted by a text string in which the input pin designation is not preceded by an exclamation point. For example, the text string, A1, indicates that the value of input pin A1 is logical high (logical zero), i.e., A1=1.

In FIG. 4A, recalling that the subject gate of bundle(Z1) is the gate A which has output pin ZA, the when-statement for the first entry in array prfrmnc_data 452(1) indicates that the causal combination is !A1&!A2&!A3& . . . &!Mn&preset_side_pin_pattern_for_ZA. The text string, preset_side_pin_pattern_for_ZA is shown in FIG. 4B and represents the sole combination of values attributable to the input pins of the M−1 other gates which is being taken into consideration during the calculation of the performance data value for the corresponding entry in array prfrmnc_data 452(1). Accordingly, the first entry in array prfrmnc_data 452(1) corresponds to the causal combination 0&0&0& . . . &0&preset_side_pin_pattern_for_ZA. The when-statement for the last entry in array prfrmnc_data 452(1) indicates that the causal combination is A1&A2&A3& . . . &Mn&preset_side_pin_pattern_for_ZA. Accordingly, the first entry in array prfrmnc_data 452(1) corresponds to the causal combination 1&1&1& . . . &1&preset_side_pin_pattern_for_ZA.

Regarding exploded view 454(2) of prfrmnc_data 452(2), and recalling that the subject gate of bundle(Z2) is the gate M which has output pin ZM, the when-statement for the first entry in array prfrmnc_data 452(2) indicates that the causal combination is !M1&!M2&!M3& . . . &!Mn&preset_side_pin_pattern_for_ZM. The text string, preset_side_pin_pattern_for_ZM is shown in FIG. 4C and represents the sole combination of values attributable to the input pins of the M−1 other gates which is being taken into consideration during the calculation of the performance data value for the corresponding entry in array prfrmnc_data 452(1). Accordingly, the first entry in array prfrmnc_data 452(1) corresponds to the causal combination 0&0&0& . . . &0&preset_side_pin_pattern_for_ZA. The when-statement for the last entry in array prfrmnc_data 452(1) indicates that the causal combination is M1&M2&M3& . . . &Mn&preset_side_pin_pattern_for_ZA. Accordingly, the first entry in array prfrmnc_data 452(1) corresponds to the causal combination 1&1&1& . . . &1&preset_side_pin_pattern_for_ZA.

Regarding FIG. 4A, in some embodiments, the performance data for the given subject gate assumes one slew rate and one load value for the subject gate, which is referred to herein as one shade of the performance data for the given subject gate. In some embodiments, slew rate for a given input pin of a given gate is the rate of change in the amplitude of the signal from 10% to 90% of the maximum amplitude of the signal. In some embodiments, the output load more particularly refers to the capacitance of the load. In some embodiments, the performance data for the given subject gate is varied over multiple (P×R) combinations of P slew rates and R output loads such that there are P×R shades of the performance data for the given subject gate, where P and R are corresponding positive integers and at least one of 2≤P or 2≤R. The P×R shades of the performance data are shown in FIG. 4A as an optional P×R sub-array 456. For example, where P=5 and R=5, there are 25 shades of the performance data for the given subject gate.

Regarding FIG. 4B, the preset_side_pin_pattern_for_ZA includes: preset sub-patterns of values for input pins B1, B2, . . . , Bn of the gate having output pins ZB; . . . ; and preset sub-patterns of values for input pins M1, M2, . . . , Mn of the gate having output pin ZM. Regarding FIG. 4C, the preset_side_pin_pattern_for_ZM includes: preset sub-patterns of values for input pins A1, A2, . . . , An of the gate having output pin ZA; . . . ; and preset sub-patterns of values for input pins L1, L2, . . . , Ln of the gate having output pin ZL.

In some embodiments, preset_side_pin_patterns such as preset_side_pin_pattern_for_ZA and preset_side_pin_pattern_for_ZM represent a worst-case scenario. In some embodiments, preset_side_pin_patterns such as preset_side_pin_pattern_for_ZA and preset_side_pin_pattern_for_ZM are determined empirically based on a big-data type of analysis of a repository of existing prior standard-cell-libraries and corresponding prior performance-data-libraries.

In some embodiments, preset_side_pin_patterns such as preset_side_pin_pattern_for_ZA and preset_side_pin_pattern_for_ZM are determined by simulation, e.g., performed by characerization tool 142, or the like.

FIG. 4D is a data structure 458 of a performance data for a standard cell, in accordance with some embodiments.

FIGS. 4E-4F are representations of corresponding combinations of values on inputs pins, in accordance with some embodiments.

FIGS. 4D-4F facilitate featurewise sorting and mapping, in accordance with at least some method embodiments disclosed herein.

In FIG. 4D, data structure 458 is an example of a data structure which characterization tool 142 populates with data for a corresponding standard cell in a standard-cell-library as part of generating performance-data-library 144. To generate performance-data-library 144, characterization tool 142 iteratively populates data structure 458 for each of the standard cells in the standard-cell-library.

Data structure 458 includes nested data structures. At a top nesting-level, data structure 458 includes a data structure, Cell(name_1), where name_1 is a variable that identifies the standard cell to which the performance data of data structure 458 pertains.

In FIG. 4D, at a next nesting-level, Cell(name_1) includes one or more grouping data structures, bundle(feature_type), where feature_type is a variable which identifies the feature-type by which members of the group are matched. In FIG. 4D, for simplicity of illustration, data structure 458 shows two instances of (feature_type), namely (I1) and (I2). In FIG. 4D, the features are assumed to be input pins; accordingly, variables I1 and I2 identify two different input pins, namely input pin I1 and input pin 12. As a practical matter, the number of instances of (feature_type) is specific to a given standard cell, and depends on the number of groups identified in the given standard cell.

At a next nesting-level, each of bundle(I1) and bundle(I2) includes: a first statement, members (feature_name, . . . ); a second statement, subject pin (pin_name); and a data structure, prfrmnc_data.

In general, the first statement, members (feature_name, . . . ), identifies the one or more members of the group. In FIG. 4D, for simplicity of discussion, each of bundle(I1) and bundle(I2) is shown as multimember group. In bundle(I1), the first instance of the first statement, members (A1, . . . , M1), identifies the members of the multimember group as the first one of the n input pins of each of the M gates, namely input pins A1, . . . , M1). In bundle(I2), the second instance of the first statement, members (An, . . . , Mn), identifies the member of the multimember group as the last one of the n input pins of each of the M gates, namely input pins An, . . . , Mn).

Regarding FIG. 4D, in general, the second statement, subject pin (pin_name), identifies one amongst the group of features as being the subject feature, i.e., as being the representative feature for which discrete calculations of performance data are to be made. The performance data which is discretely calculated for the subject feature is mapped not only to the subject feature but also is mapped to remaining ones of the features in the group, i.e., is mapped to the non-subject features in the group. Such mapping is an example of exploiting redundancies in the performance-data. In bundle(I1), the first instance of the second statement, subject pin (A1), identifies the subject feature as input pin A1. In bundle(I2), the second instance of the second statement, subject pin (An), identifies the subject feature as input pin An.

In FIG. 4D, the instance of the data structure, prfrmnc_data, in bundle(I1) is labeled with reference number 460(1), and the instance of the data structure, prfrmnc_data, in bundle(I2) is labeled with reference number 460(2). Each of prfrmnc_data 460(1)-460(1) is an array containing J*2\hat{ }\hat{ }n performance data values corresponding to the J*2\hat{ }\hat{ }n combinations attributable to the values which are applied to the n input pins of the gate which includes the subject feature and the few ones amongst the 2\hat{ }\hat{ }(n*(M−1)) combinations of values attributable to the input pins of the M−1 other features. For simplicity of illustration, FIG. 4D assumes that J=1. Prfrmnc_data 460(1) has an exploded view 462(1). Prfrmnc_data 460(2) has an exploded view 462(2).

In exploded view 462(1), the when-statements associated with the entries in array prfrmnc_data 460(1), i.e., the when-statements associated with the performance data values in array prfrmnc_data 460(1), identify the combinations of input values that produced the corresponding entries. In other words, each performance data value in array prfrmnc_data 460(1) has a when-statement which indicates the combination of values of input pins for the subject gate which includes the subject feature to which the performance data value corresponds (causal combination).

In FIG. 4D, recalling that the subject feature of bundle(I1) is input pin A1, the when-statement for the first entry in array prfrmnc_data 460(1) indicates that the causal combination is !A1&!A2&!A3& . . . &!Mn&preset_side_pin_pattern_for_A1. The text string, preset_side_pin_pattern_for_A1 is shown in FIG. 4E and represents the sole combination of values attributable to the input pins of the M−1 other features which is being taken into consideration during the calculation of the performance data value for the corresponding entry in array prfrmnc_data 460(1). Accordingly, the first entry in array prfrmnc_data 460(1) corresponds to the causal combination 0&0&0& . . . &0&preset_side_pin_pattern_for_A1. The when-statement for the last entry in array prfrmnc_data 460(1) indicates that the causal combination is A1&A2&A3& . . . &Mn&preset_side_pin_pattern_for_A1. Accordingly, the first entry in array prfrmnc_data 460(1) corresponds to the causal combination 1&1&1& . . . &1&preset_side_pin_pattern_for_A1.

Regarding exploded view 462(2) of prfrmnc_data 460(2), and recalling that the subject feature of bundle(I2) is input pin A2, the when-statement for the first entry in array prfrmnc_data 460(2) indicates that the causal combination is !M1&!M2&!M3& . . . &!Mn&preset_side_pin_pattern_for_An. The text string, preset_side_pin_pattern_for_An is shown in FIG. 4F and represents the sole combination of values attributable to the input pins of the M−1 other features which is being taken into consideration during the calculation of the performance data value for the corresponding entry in array prfrmnc_data 460(1). Accordingly, the first entry in array prfrmnc_data 460(1) corresponds to the causal combination 0&0&0& . . . &0&preset_side_pin_pattern_for_An. The when-statement for the last entry in array prfrmnc_data 460(1) indicates that the causal combination is M1&M2&M3& . . . &Mn&preset_side_pin_pattern_for_An. Accordingly, the first entry in array prfrmnc_data 460(1) corresponds to the causal combination 1&1&1& . . . &1&preset_side_pin_pattern_for_An.

Regarding FIG. 4D, in some embodiments, the performance data for the given subject feature assumes one slew rate and one load value for the subject feature, which is referred to herein as one shade of the performance data for the given subject feature. In some embodiments, the performance data for the given subject feature is varied over multiple (P×R) combinations of P slew rates and R output loads such that there are P×R shades of the performance data for the given subject feature, where P and R are corresponding positive integers and at least one of 2≤P or 2≤R. The P×R shades of the performance data are shown in FIG. 4D as an optional P×R sub-array 464. For example, where P=5 and R=5, there are 25 shades of the performance data for the given subject feature.

FIGS. 5A-5F are corresponding data structures 550A-550F for performance data, in accordance with some embodiments.

FIGS. 5A-5F are similar to FIG. 4A. In some embodiments, an arc is another term for a performance datum.

In FIG. 5A, data structure 550A includes two instances of a data structure, timing_arc, labeled with corresponding reference numbers 552(1)-552(2), which are examples of corresponding data structures 452(1)-452(2) of FIG. 4A. Each of timing_arc 552A(1)-552A(2) is a type of performance datum that represents an elapsed time during which the subject gate generates a corresponding stable output value, i.e., the propagation delay. Each of timing_arc 552A(1)-552A(2) includes a statement, temperature: temp_value, where temp_value is a variable representing a temperature at which the subject gate exhibits the corresponding propagation delay.

In FIG. 5B, data structure 550B includes two instances of a data structure, power_arc, labeled with corresponding reference numbers 552B(1)-552B(2), which are examples of corresponding data structures 452(1)-452(2) of FIG. 4A. Each of power_arc 552B (1)-552B(2) is a type of performance datum that represents an amount of power consumed while the subject gate generates a corresponding stable output value. Each of power_arc 552B (1)-552B(2) includes a statement, temperature: temp_value, where temp_value is a variable representing a temperature at which the subject gate exhibits the corresponding power consumption.

In FIG. 5C, data structure 550C includes two instances of a data structure, setup-time arc, labeled with corresponding reference numbers 552C(1)-552C(2), which are examples of corresponding data structures 452(1)-452(2) of FIG. 4A. Each of setup-time arc 552C(1)-552C(2) is a type of performance datum that represents a minimum elapsed time that output data must be held stable by the subject gate before a next active clock edge. Each of setup-time arc 552C(1)-552C(2) includes a statement, temperature: temp_value, where temp_value is a variable representing a temperature at which the subject gate exhibits the corresponding setup-time.

In FIG. 5D, data structure 550D includes two instances of a data structure, hold-time arc, labeled with corresponding reference numbers 552D(1)-552D(2), which are examples of corresponding data structures 452(1)-452(2) of FIG. 4A. Each of hold-time arc 552D(1)-552D(2) is a type of performance datum that represents a minimum elapsed time that inputs to the subject gate must be held stable after an active clock edge. Each of setup-time arc 552D(1)-552D(2) includes a statement, temperature: temp_value, where temp_value is a variable representing a temperature at which the subject gate exhibits the corresponding hold-time.

In FIG. 5E, data structure 550E includes two instances of a data structure, recovery-time arc, labeled with corresponding reference numbers 552E(1)-552E(2), which are examples of corresponding data structures 452(1)-452(2) of FIG. 4A. Each of reccovery-time arc 552E(1)-552E(2) is a type of performance datum that represents a minimum permissible elapsed time from de-assertion of a reset signal to a next active clock edge required by the subject gate. Each of recovery-time arc 552E(1)-552E(2) includes a statement, temperature: temp_value, where temp_value is a variable representing a temperature at which the subject gate exhibits the corresponding recovery-time.

In FIG. 5F, data structure 550F includes two instances of a data structure, removal-time arc, labeled with corresponding reference numbers 552F(1)-552F(2), which are examples of corresponding data structures 452(1)-452(2) of FIG. 4A. Each of removal-time arc 552F(1)-552F(2) is a type of performance datum that represents a minimum permissible elapsed time after a next active clock edge before which a reset signal is de-asserted by the subject gate. Each of recovery-time arc 552F(1)-552F(2) includes a statement, temperature: temp_value, where temp_value is a variable representing a temperature at which the subject gate exhibits the corresponding removal-time.

FIGS. 5G-5N are corresponding data structures 558G-558N for performance data, in accordance with some embodiments.

FIGS. 5G-5N are similar to FIG. 4A. In some embodiments, an arc is another term for a performance datum.

In FIG. 5G, data structure 558G includes two instances of a data structure, timing_arc, labeled with corresponding reference numbers 552(1)-552(2), which are examples of corresponding data structures 460(1)-460(2) of FIG. 4D. Each of timing_arc 552G(1)-552G(2) is a type of performance datum that represents an elapsed time during which the subject gate generates a corresponding stable output value, i.e., the propagation delay. In some embodiments, the elapsed time represented by the timing_arc is from an active edge of a clock signal until the subject gate generates the corresponding stable output value. Each of timing_arc 552G(1)-552G(2) includes a statement, temperature: temp_value, where temp_value is a variable representing a temperature at which the subject gate exhibits the corresponding propagation delay. Each of timing_arc 552G(1)-552G(2) also includes a statement, relative_pin: name_2, where name_2 is a variable representing a name of an input pin that is included in a path of interest, e.g., the input pin for the clock signal CP in FIG. 3D, or the like.

In FIG. 5H, data structure 558H includes two instances of a data structure, power_arc, labeled with corresponding reference numbers 552H(1)-552H(2), which are examples of corresponding data structures 460(1)-460(2) of FIG. 4D. Each of power_arc 552H(1)-552H(2) is a type of performance datum that represents an amount of power consumed while the subject gate generates a corresponding stable output value. Each of power_arc 552H(1)-552H(2) includes a statement, temperature: temp_value, where temp_value is a variable representing a temperature at which the subject gate exhibits the corresponding power consumption. Each of power_arc 552H(1)-552H(2) also includes a statement, relative_pin: name_2, where name_2 is a variable representing a name of an input pin that is included in a path of interest, e.g., the input pin for the clock signal CP in FIG. 3D, or the like.

In FIG. 5I, data structure 558I includes two instances of a data structure, setup-time arc, labeled with corresponding reference numbers 552I(1)-552I(2), which are examples of corresponding data structures 460(1)-460(2) of FIG. 4D. Each of setup-time arc 552I(1)-552I(2) is a type of performance datum that represents a minimum elapsed time that output data must be held stable by the subject gate before a next active clock edge. Each of setup-time arc 552I(1)-552I(2) includes a statement, temperature: temp_value, where temp_value is a variable representing a temperature at which the subject gate exhibits the corresponding setup-time. Each of setup-time arc 552I(1)-552I(2) also includes a statement, relative_pin: name_2, where name_2 is a variable representing a name of an input pin that is included in a path of interest, e.g., the input pin for the clock signal CP in FIG. 3D, or the like.

In FIG. 5J, data structure 558J includes two instances of a data structure, hold-time arc, labeled with corresponding reference numbers 552J(1)-552J(2), which are examples of corresponding data structures 460(1)-460(2) of FIG. 4D. Each of hold-time arc 552J(1)-552J(2) is a type of performance datum that represents a minimum elapsed time that inputs to the subject gate must be held stable after an active clock edge. Each of setup-time arc 552J(1)-552J(2) includes a statement, temperature: temp_value, where temp_value is a variable representing a temperature at which the subject gate exhibits the corresponding hold-time. Each of hold arc 552J(1)-552J(2) also includes a statement, relative_pin: name_2, where name_2 is a variable representing a name of an input pin that is included in a path of interest, e.g., the input pin for the clock signal CP in FIG. 3D, or the like.

In FIG. 5K, data structure 558K includes two instances of a data structure, recovery-time arc, labeled with corresponding reference numbers 552K(1)-552K(2), which are examples of corresponding data structures 460(1)-460(2) of FIG. 4D. Each of reccovery-time arc 552K(1)-552K(2) is a type of performance datum that represents a minimum permissible elapsed time from de-assertion of a reset signal to a next active clock edge required by the subject gate. Each of recovery-time arc 552K(1)-552K(2) includes a statement, temperature: temp_value, where temp_value is a variable representing a temperature at which the subject gate exhibits the corresponding recovery-time. Each of recovery-time arc 552K(1)-552K(2) also includes a statement, relative_pin: name_2, where name_2 is a variable representing a name of an input pin that is included in a path of interest, e.g., the input pin for the clock signal CP in FIG. 3D, or the like.

In FIG. 5L, data structure 558L includes two instances of a data structure, removal-time arc, labeled with corresponding reference numbers 552L(1)-552L(2), which are examples of corresponding data structures 460(1)-460(2) of FIG. 4D. Each of removal-time arc 552L(1)-552L(2) is a type of performance datum that represents a minimum permissible elapsed time after a next active clock edge before which a reset signal is de-asserted by the subject gate. Each of recovery-time arc 552L(1)-552L(2) includes a statement, temperature: temp_value, where temp_value is a variable representing a temperature at which the subject gate exhibits the corresponding removal-time. Each of removal-time arc 552L(1)-552L(2) also includes a statement, relative_pin: name_2, where name_2 is a variable representing a name of an input pin that is included in a path of interest, e.g., the input pin for the clock signal CP in FIG. 3D, or the like.

In FIG. 5M, data structure 558M includes two instances of a data structure, clear-time arc, labeled with corresponding reference numbers 552M(1)-552M(2), which are examples of corresponding data structures 460(1)-460(2) of FIG. 4D. Each of clear-time arc 552M(1)-552M(2) is a type of performance datum that represents a minimum elapsed time after a clear pin is activated for the subject gate to generate a stable logical low output value. Each of clear-time arc 552M(1)-552M(2) includes a statement, temperature: temp_value, where temp_value is a variable representing a temperature at which the subject gate exhibits the corresponding clear-time. Each of clear-time arc 552M(1)-552M(2) also includes a statement, relative_pin: name_2, where name_2 is a variable representing a name of an input pin that is included in a path of interest, e.g., the input pin for the clock signal CP in FIG. 3D, or the like.

In FIG. 5N, data structure 558N includes two instances of a data structure, preset-time arc, labeled with corresponding reference numbers 552N(1)-552N(2), which are examples of corresponding data structures 460(1)-460(2) of FIG. 4D. Each of preset-time arc 552M(1)-552M(2) is a type of performance datum that represents a minimum elapsed time after a preset pin is activated for the subject gate to generate a stable logical high output value. Each of preset-time arc 552N(1)-552N(2) includes a statement, temperature: temp_value, where temp_value is a variable representing a temperature at which the subject gate exhibits the corresponding preset-time. Each of prese-timet arc 552M(1)-552M(2) also includes a statement, relative_pin: name_2, where name_2 is a variable representing a name of an input pin that is included in a path of interest, e.g., the input pin for the clock signal CP in FIG. 3D, or the like.

In some embodiments, for a given standard library which includes a given flip-flop gate, a corresponding instance of performance data library 144 has corresponding performance data volumes for the given flip-flop including a first set of volumes for propagation delay, a second set of volumes for timing arc, a third set of volumes for power arc, a fourth set of volumes for setup-time, a fifth set of volumes for hold-time, a sixth set of volumes for recovery-time, a seventh set of volumes for removal-time, an eighth set of volumes for clear-time and/or a ninth set of volumes for preset-time, where not all of the sets of volumes are grouped in the same way. In some embodiments, the corresponding performance data volumes for the given flip-flop including a first set of volumes for propagation delay, a second set of volumes for timing arc, a third set of volumes for power arc, a fourth set of volumes for setup-time, a fifth set of volumes for hold-time, a sixth set of volumes for recovery-time, a seventh set of volumes for removal-time, an eighth set of volumes for clear-time and/or a ninth set of volumes for preset-time, where each of the first to ninth sets is grouped in a different way.

FIG. 6A is a block diagram of a standard cell 666A, in accordance with some embodiments.

In FIG. 6A, standard cell 666A is assumed to be a multibit flip-flop that includes two instances of a single-bit flip-flop gate 668(1), one instance of a single-bit flip-flop gate 668(2), three instances of a single-bit flip-flop gate 668(3), and one instance of a single-bit flip-flop gate 668(4). Relative to FIG. 6A, the attribute of the gate as a whole on which is based the sorting and matching according to various embodiments disclosed herein is gate-type, and more particularly where gate-type refers the height of the gate. Relative to the Y-axis, gate 668(1) has a height of ½ H, where H is a unit of measure for a corresponding semiconductor process technology node. Gate 668(2) has a height of 2H. Gate 668(3) has a height of H. Gate 668(4) has a height of 1.5H. Other gate heights are contemplated. Relative to the X-axis, each of gates 668(1)-668(3) has the same width. In some embodiments, standard cell 666A is a cell other than a multibit flip-flop cell, and gates 668(1)-668(4) are gates other than single-bit flip-flop gates.

FIG. 6B is a block diagram of a standard cell 666B, in accordance with some embodiments.

In FIG. 6B, standard cell 666B is assumed to be a multibit flip-flop that includes two instances of a single-bit flip-flop gate 668(5), three instances of a single-bit flip-flop gate 668(6), and two instances of a single-bit flip-flop gate 668(7). Relative to FIG. 6B, the attribute of the gate as a whole on which is based the sorting and matching according to various embodiments disclosed herein is gate-type, more particularly where gate-type refers to a number of fins 670 in the corresponding gate. Gate 668(5) has six instances of fin 670. Gate 668(6) has eight instances of fin 670. Gate 668(7) has four instances of fin 670. Other numbers of instances of fin 670 are contemplated. Relative to the X-axis, each of gates 668(5)-668(7) has the same width. Relative to the Y-axis, each of gates 668(5)-668(7) has the same height. In some embodiments, standard cell 666B is a cell other than a multibit flip-flop cell, and gates 668(5)-668(7) are gates other than single-bit flip-flop gates.

FIG. 6C is a block diagram of a standard cell 666C, in accordance with some embodiments.

In FIG. 6C, standard cell 666C is assumed to be a multibit flip-flop that includes two instances of a single-bit flip-flop gate 668(8), one instance of a single-bit flip-flop gate 668(9), three instances of a single-bit flip-flop gate 668(10), and one instance of a single-bit flip-flop gate 668(11). Relative to FIG. 6C, the attribute of the gate as a whole on which is based the sorting and matching according to various embodiments disclosed herein is gate-type, and more particularly where gate-type refers the width of the gate. Relative to the X-axis, gate 668(8) has a width of ½ W, where W is a unit of measure, e.g., contacted poly pin (CPP), for a corresponding semiconductor process technology node. Gate 668(9) has a width of 2 W. Gate 668(10) has a width of W. Gate 668(11) has a width of 1.5 W. Other gate widths are contemplated. Relative to the Y-axis, each of gates 668(8)-668(11) has the same height. In some embodiments, standard cell 666C is a cell other than a multibit flip-flop cell, and gates 668(8)-668(11) are gates other than single-bit flip-flop gates.

FIG. 6C is a block diagram of a standard cell 666C, in accordance with some embodiments.

In FIG. 6C, standard cell 666C is assumed to be a multibit flip-flop that includes one instance of a single-bit flip-flop gate 668(12), three instances of a single-bit flip-flop gate 668(13), and one instance of a single-bit flip-flop gate 668(14). Relative to FIG. 6C, the attribute of the gate as a whole on which is based the sorting and matching according to various embodiments disclosed herein is gate-type, more particularly where gate-type refers to a number of nanosheets 672 in each of the PMOS and NMOS active regions in the corresponding gate. Gate 668(12) has a two instances of nanosheet 672 in each of the PMOS and NMOS active regions. Gate 668(13) has six instances of nanosheet 672 in each of the PMOS and NMOS active region. Gate 668(14) has four instances of nanosheet 672 in each of the PMOS and NMOS active region. Other numbers of instances of nanosheet 672 in the PMOS and NMOS active regions are contemplated. Relative to the X-axis, each of gates 668(12)-668(14) has the same width. Relative to the Y-axis, each of gates 668(12)-668(14) has the same height. In some embodiments, gates 668(12)-668(14) are configured with nanowires, or the like, rather than nanosheets. In some embodiments, standard cell 666D is a cell other than a multibit flip-flop cell, and gates 668(12)-668(14) are gates other than single-bit flip-flop gates.

FIGS. 6E-6F are circuit diagrams of corresponding single-bit flip-flop topologies included in a standard cell, in accordance with some embodiments.

In some embodiments, gate-type refers to the circuit topology of the gate, e.g., transmission gate topology (FIG. 6E) versus stack-gate topology (FIG. 6F). FIG. 6E is a circuit diagram of a transmission gate topology which includes a transmission gate (TXG) coupled between a master latch and a slave latch. The TXG receives a clock_bar signal clkb and a clock_bar_bar signal clkbb. FIG. 6D is a circuit diagram of a stack-gate topology which includes a stack-gate (SXG) circuit coupled between a master latch and a slave latch. The SXG circuit receives the clock_bar signal clkb and the clock_bar_bar signal clkbb.

FIGS. 6G-6H are circuit diagrams of corresponding single-bit flip-flop topologies included in a standard cell, in accordance with some embodiments.

In some embodiments, in a context of transmission gate topology, gate-type refers to the sub-circuit topology of Q-type coupler (FIG. 6G) versus RPQ-type coupler (FIG. 6H). FIG. 6G is a circuit diagram of a Q-type coupler topology which includes a Q-type circuit between a master latch and a transmission gate (TXG), the TXG coupling the Q-type circuit to a slave latch. Each of the master latch, Q-type circuit, TXG and slave latch receives a clock_bar signal clkb and a clock_bar_bar signal clkbb. The master latch additionally receives: a data signal, D; a scan input signal, SI; a scan enable, SE; and an SE_bar signal, seb. In some embodiments, the single-bit flip-flop of FIG. 6G is referred to as an example of a scan D flip-flop (SDFQ). FIG. 6D is a circuit diagram of an RPQ-type coupler topology which includes an RPQ-type circuit between a master latch and a transmission gate (TXG), the TXG coupling the RPQ-type circuit to a slave latch. Each of the master latch, RPQ-type circuit, TXG and slave latch receives a clock bar signal clkb and a clock_bar_bar signal clkbb. The master latch additionally receives: a data signal, D; a scan input signa, l SI; a scan enable, SE; and an SE_bar signal, seb. In some embodiments, the single-bit flip-flop of FIG. 6H is referred to as an example of an SDFQ.

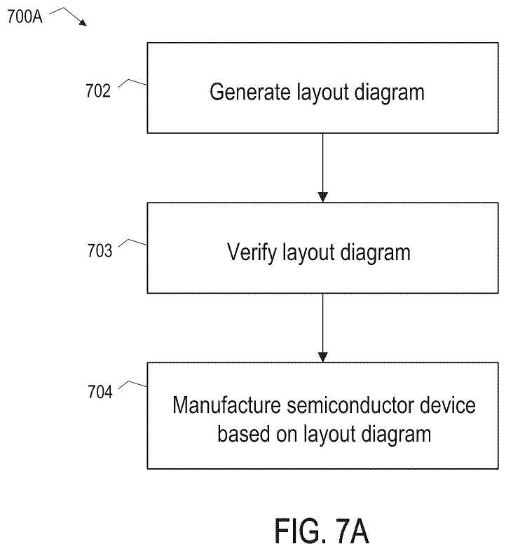

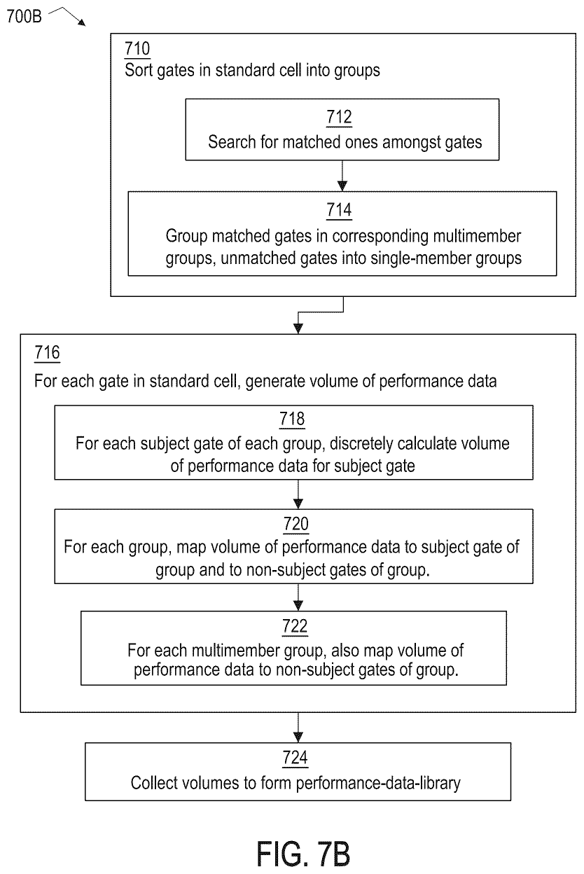

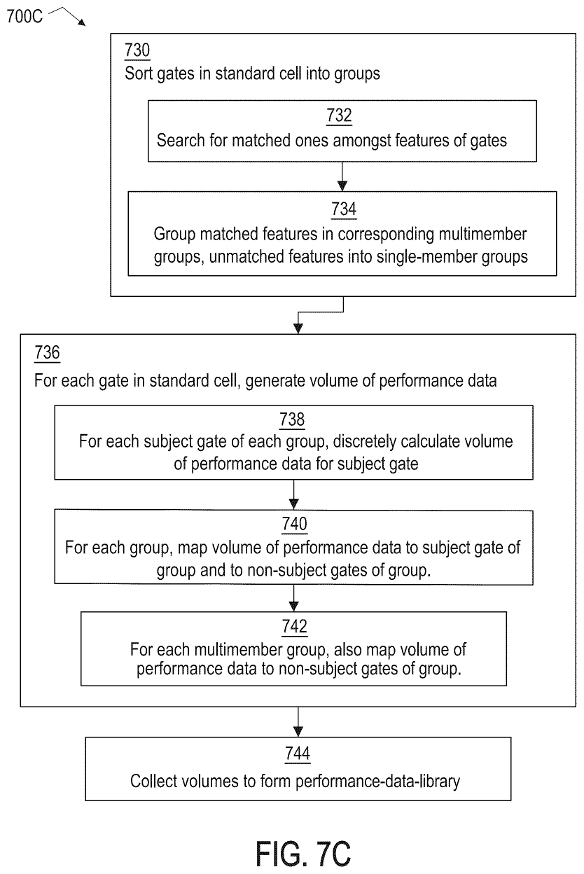

FIG. 7A is a flow diagram 700A of a method of manufacturing a semiconductor device, in accordance with some embodiments.

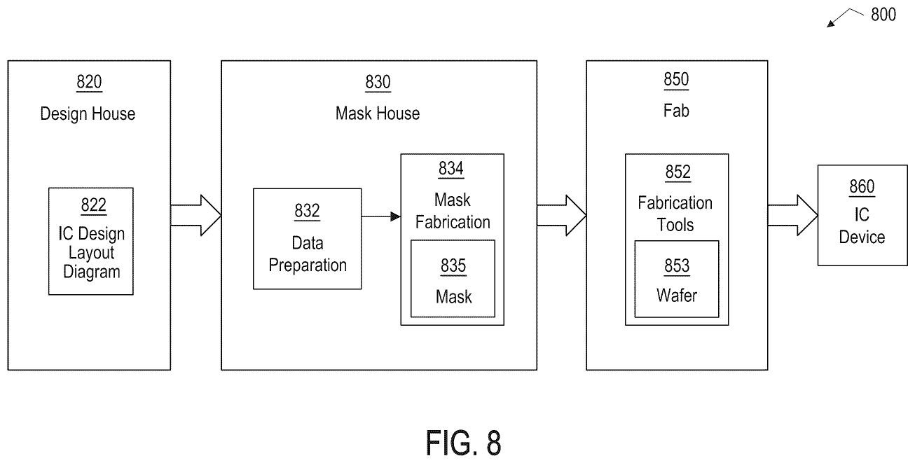

The method of flowchart 700A is implementable, for example, using EDA system 100A (FIG. 1A, discussed above) and an IC manufacturing system 800 (FIG. 8, discussed below), in accordance with some embodiments. Examples of a semiconductor device which can be manufactured according to the method of flowchart 700A include semiconductor devices based on layout diagrams the verification of which is based, at least in part, on performance data libraries, e.g., 144, generated according to one or more methods disclosed herein, or the like.

In FIG. 7A, the method of flowchart 700A includes blocks 702-704. At block 702, a layout diagram is generated. Block 702 is implementable, for example, using EDA system 100A (FIG. 1A, discussed above), in accordance with some embodiments. From block 702, flow proceeds to block 703.

At block 703, the layout diagram is subjected to various verification processes which are based, at least in part, on performance data libraries, e.g., 144, generated according to one or more methods disclosed herein, or the like. Block 703 is implementable, for example, using EDA system 100A (FIG. 1A, discussed above), in accordance with some embodiments. From block 703, flow proceeds to block 703.

At block 704, based on the layout diagram, at least one of (A) one or more photolithographic exposures are made or (b) one or more semiconductor masks are fabricated or (C) one or more components in a layer of a semiconductor device are fabricated. See discussion below of IC manufacturing system 800 in FIG. 8 below.

FIG. 7B is a method 700B of generating a performance-data-library in accordance with some embodiments.

The method of flowchart 700B is implementable, for example, using characterization tool 142 of FIG. 1B, or the like. In some embodiments, characterization tool 142 is implementable using EDA system 100A (FIG. 1A, discussed above) Examples of the performance-data-library generated according to the method of flowchart 700B include performance-data-library 144, or the like.

Method 700B includes blocks 710-724. At block 710, for each standard cell in a corresponding standard-cell-library, gates in the standard cell are sorted into groups. Block 710 includes blocks 1712-714. Within block 710, flow proceeds to block 712.

At block 712, for a given standard cell, the gates are searched on a gatewise basis for matching ones. For gatewise matching, the attribute of the gate as a whole on which is based the sorting and matching is gate-type. In some embodiments, gate-type refers to the function performed by the gate (FIG. 2B, or the like). In some embodiments, gate-type refers to a current-driving capability at the output pin of the gate. In some embodiments, gate-type refers to a threshold voltage of transistors in the gate. In some embodiments, gate-type refers to a power domain in which the gate operates. In some embodiments, gate-type refers to the height of the gate relative to the Y-axis (FIG. 6A, or the like). In some embodiments, gate-type refers to the number of fins in the gate (FIG. 6B, or the like). In some embodiments, gate-type refers the width of the gate relative to the X-axis (FIG. 6C, or the like). In some embodiments, gate-type refers to the number of nanosheets in each of the PMOS and NMOS active regions of the gate (FIG. 6D, or the like). In some embodiments, gate-type refers to the circuit topology of the gate, e.g., transmission gate topology (FIG. 6E, or the like) versus stack-gate topology (FIG. 6F, or the like). In some embodiments, in a context of transmission gate topology, gate-type refers to the sub-circuit topology of Q-type coupler (FIG. 6G, or the like) versus RPQ-type coupler (FIG. 6H, or the like), or the like. From block 712, flow proceeds to block 714.

At block 714, for the given standard cell, matched gates are grouped in corresponding multimember groups. Unmatched ones of the gates are grouped in corresponding single-member groups. An example of a multimember group is 202B in FIG. 2B, or the like. An example of a single-member group is 204 in FIG. 2B, or the like. From block 714, flow exits block 710 and proceeds to block 716.

At block 716, for each standard cell, a volume of performance data is generated for each gate in the standard cell. Block 716 includes blocks 718-722. Within block 716, flow proceeds to block 718.

At block 718, for each subject gate in a group, the volume of performance data is discretely calculated. Examples of subject gates include 306(1) in FIG. 3A, 306(2) in FIG. 3B, 306(M) in FIG. 3C, the gate (not shown) having output pin ZA as listed in data structure 450 of FIG. 4A, 550A of FIG. 5A, 550B of FIG. 5B, 550C of FIG. 5C, 550D of FIG. 5D, 550E of FIG. 5E, 550F of FIG. 5E, or the like. From block 718, flow proceeds to block 720.

At block 720, for each group, the volume of performance data is mapped to the subject gate of the group. Examples of such mapping include: regarding multimember groups, the members statement in each of data structure 450 of FIG. 4A, 550A of FIG. 5A, 550B of FIG. 5B, 550C of FIG. 5C, 550D of FIG. 5D, 550E of FIG. 5E, 550F of FIG. 5E, or the like, which identifies the subject gate among other members, i.e., non-subject gates, of the multimember group; and regarding single-member groups, the members statement in each of data structure 450 of FIG. 4A, 550A of FIG. 5A, 550B of FIG. 5B, 550C of FIG. 5C, 550D of FIG. 5D, 550E of FIG. 5E, 550F of FIG. 5E, or the like, which identifies the subject gate, where the subject gate is the sole member of the single-member group; or the like. From block 720, flow proceeds to block 724.

At block 724, for each group that is a multi-member group, the volume of performance data is also mapped to the non-subject gates in the multimember group. Such mapping is an example of exploiting redundancies in the performance-data. The performance data of the non-subject gates in the group is redundant to the performance data of the subject group. Accordingly, such mapping exploits avoids making discrete calculations of otherwise redundant performance data and thus exploits redundancies in the performance-data of the non-subject groups. Examples of such mapping include the members statement for the multimember group in each of data structure 450 of FIG. 4A, 550A of FIG. 5A, 550B of FIG. 5B, 550C of FIG. 5C, 550D of FIG. 5D, 550E of FIG. 5E, 550F of FIG. 5E, or the like, which identifies the non-subject gates of the multimember group as was as the subject gate of the multimember group, or the like. From block 722, flow exits block 716 and flows to block 724.

At block 724, the volumes of performance data are collected to form the performance-data-library. Again, an example of the performance-data-library is performance-data-library 144 of FIG. 1B, or the like. In some embodiments, the first performance-data-library is based at least in part on the volumes of performance.

In some embodiments, block 730 further includes: before the searching for matched ones amongst the gates (matched gates), setting a status of each gate to be unsorted (unsorted status). In such embodiments, the searching for matched ones amongst the gates (matched gates) includes: for a target one of the gates (target gate) relative to which other ones of the gates are non-target gates, comparing a description of the target gate to descriptions correspondingly of the non-target gates to recognize which one or more of the non-target gates matches the target gate (recognized gates); deeming the target gate and the recognized gates to be matching gates; and setting the status of the target gate and the recognized gates to be sorted. In such embodiments, for remaining gates having the unsorted status, the searching for matched ones amongst the gates (matched gates) is iterated until no unmatched gates remain.

FIG. 7C is a method 700C of generating a performance-data-library in accordance with some embodiments.

The method of flowchart 700C is implementable, for example, using characterization tool 142 of FIG. 1B, or the like. In some embodiments, characterization tool 142 is implementable using EDA system 100A (FIG. 1A, discussed above) Examples of the performance-data-library generated according to the method of flowchart 700C include performance-data-library 144, or the like.

Method 700C includes blocks 730-744. At block 730, for each standard cell in a corresponding standard-cell-library, gates in the standard cell are sorted into groups. Block 730 includes blocks 1732-734. Within block 730, flow proceeds to block 732.

At block 732, for a given standard cell, the gates are searched on a featurewise basis for matching ones. For featurewise matching, the attribute on which is based the sorting and matching is a feature of the gate. In some embodiments, the feature of the gate is an individual input pins, i.e., each input pin resents a features of a given gate (FIG. 2C, 3D, or the like). From block 732, flow proceeds to block 734.

At block 734, for the given standard cell, matched features are grouped in corresponding multi-feature groups. Unmatched ones of the features are grouped in corresponding single-feature groups. Examples of a multimembers group include 202C(1)-202C(3) in FIG. 2C, or the like. An example of a single-member group is identified as 12 by data structure 458 in FIG. 4D, or the like. From block 734, flow exits block 730 and proceeds to block 736.

At block 736, for each standard cell, a volume of performance data is generated for each gate in the standard cell. Block 736 includes blocks 738-742. Within block 736, flow proceeds to block 738.

At block 738, for each subject gate in a group, the volume of performance data is discretely calculated. Examples of subject gates include 307(1) in FIG. 3D, the gate (not shown) having input pin A1 as listed in data structure 458 of FIG. 4D, 558G of FIG. 5G, 558H of FIG. 5H, 558I of FIG. 5I, 558J of FIG. 5J, 558K of FIG. 5K, 558L of FIG. 5L, 558M of FIG. 5M, 558N of FIG. 5N, or the like. From block 738, flow proceeds to block 740.

At block 740, for each group, the volume of performance data is mapped to the subject gate of the group. Examples of such mapping include: regarding multimember groups, the members statement in each of data structure 458 of FIG. 4D, 558G of FIG. 5G, 558H of FIG. 5H, 558I of FIG. 5I, 558J of FIG. 5J, 558K of FIG. 5K, 558L of FIG. 5L, 558M of FIG. 5M, 558N of FIG. 5N, or the like, which identifies the subject gate among other members, i.e., non-subject gates, of the multimember group; and, regarding single-member groups, the members statement in each of data structure 458 of FIG. 4D, 558G of FIG. 5G, 558H of FIG. 5H, 558I of FIG. 5I, 558J of FIG. 5J, 558K of FIG. 5K, 558L of FIG. 5L, 558M of FIG. 5M, 558N of FIG. 5N, or the like, which identifies the subject gate, where the subject gate is the sole member of the single-member group; or the like. From block 740, flow proceeds to block 744.

At block 744, for each group that is a multi-member group, the volume of performance data is also mapped to the non-subject gates in the multimember group. Such mapping is an example of exploiting redundancies in the performance-data. The performance data of the non-subject gates in the group is redundant to the performance data of the subject group. Accordingly, such mapping exploits avoids making discrete calculations of otherwise redundant performance data and thus exploits redundancies in the performance-data of the non-subject groups. Examples of such mapping include the members statement for the multimember group in each of data structure 458 of FIG. 4D, 558G of FIG. 5G, 558H of FIG. 5H, 558I of FIG. 5I, 558J of FIG. 5J, 558K of FIG. 5K, 558L of FIG. 5L, 558M of FIG. 5M, 558N of FIG. 5N, or the like, or the like, which identifies the non-subject gates of the multimember group as was as the subject gate of the multimember group, or the like. From block 742, flow exits block 736 and flows to block 744.

At block 744, the volumes of performance data are collected to form the performance-data-library. Again, an example of the performance-data-library is performance-data-library 144 of FIG. 1B, or the like. In some embodiments, the first performance-data-library is based at least in part on the volumes of performance data.

FIG. 8 is a block diagram of an integrated circuit (IC) manufacturing system 800, and an IC manufacturing flow associated therewith, in accordance with some embodiments.

After block 703 of FIG. 7A, based on the layout, at least one of (A) one or more semiconductor masks or (B) at least one component in a layer of an inchoate semiconductor integrated circuit is fabricated using manufacturing system 800.

In FIG. 8, IC manufacturing system 800 includes entities, such as a design house 820, a mask house 830, and an IC manufacturer/fabricator (“fab”) 850, that interact with one another in the design, development, and manufacturing cycles and/or services related to manufacturing an IC device 860. The entities in system 800 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and supplies services to and/or receives services from one or more of the other entities. In some embodiments, two or more of design house 820, mask house 830, and IC fab 850 is owned by a single larger company. In some embodiments, two or more of design house 820, mask house 830, and IC fab 850 coexist in a common facility and use common resources.

Design house (or design team) 820 generates an IC design layout 822. IC design layout 822 includes various geometrical patterns designed for an IC device 860. The geometrical patterns correspond to patterns of metal, oxide, or semiconductor layers that make up the various components of IC device 860 to be fabricated. The various layers combine to form various IC features. For example, a portion of IC design layout 822 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 820 implements a proper design procedure to form IC design layout 822. The design procedure includes one or more of logic design, physical design or place and route. IC design layout 822 is presented in one or more data files having information of the geometrical patterns. For example, IC design layout 822 is expressed in a GDSII file format or DFII file format.

Mask house 830 includes data preparation 832 and mask fabrication 834. Mask house 830 uses IC design layout 822 to manufacture one or more masks to be used for fabricating the various layers of IC device 860 according to IC design layout 822. Mask house 830 performs mask data preparation 832, where IC design layout 822 is translated into a representative data file (“RDF”). Mask data preparation 832 supplies the RDF to mask fabrication 834. Mask fabrication 834 includes a mask writer. A mask writer converts the RDF to an image on a substrate, such as a mask (reticle) or a semiconductor wafer. The design layout is manipulated by mask data preparation 832 to comply with particular characteristics of the mask writer and/or requirements of IC fab 850. In FIG. 8, mask data preparation 832, mask fabrication 834, and mask 835 are illustrated as separate elements. In some embodiments, mask data preparation 832 and mask fabrication 834 are collectively referred to as mask data preparation.

In some embodiments, mask data preparation 832 includes optical proximity correction (OPC) which uses lithography enhancement techniques to compensate for image errors, such as those that can arise from diffraction, interference, other process effects and the like. OPC adjusts IC design layout 822. In some embodiments, mask data preparation 832 includes further resolution enhancement techniques (RET), such as off-axis illumination, sub-resolution assist features, phase-shifting masks, other suitable techniques, and the like or combinations thereof. In some embodiments, inverse lithography technology (ILT) is further used, which treats OPC as an inverse imaging problem.

In some embodiments, mask data preparation 832 includes a mask rule checker (MRC) that checks the IC design layout that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout to compensate for limitations during mask fabrication 834, which may undo part of the modifications performed by OPC in order to meet mask creation rules.

In some embodiments, mask data preparation 832 includes lithography process checking (LPC) that simulates processing that will be implemented by IC fab 850 to fabricate IC device 860. LPC simulates this processing based on IC design layout 822 to fabricate a simulated manufactured device, such as IC device 860. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been fabricated by LPC, if the simulated device is not close enough in shape to satisfy design rules, OPC and/or MRC are be repeated to further refine IC design layout 822.

The above description of mask data preparation 832 has been simplified for the purposes of clarity. In some embodiments, data preparation 832 includes additional features such as a logic operation (LOP) to modify the IC design layout according to manufacturing rules. Additionally, the processes applied to IC design layout 822 during data preparation 832 may be executed in a variety of different orders.

After mask data preparation 832 and during mask fabrication 834, a mask 835 or a group of masks are fabricated based on the modified IC design layout. In some embodiments, an electron-beam (e-beam) or a mechanism of multiple e-beams is used to form a pattern on a mask (photomask or reticle) based on the modified IC design layout. The masks are formed in various technologies. In some embodiments, the mask is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask includes a transparent substrate (e.g., fused quartz) and an opaque material (e.g., chromium) coated in the opaque regions of the mask. In another example, the mask is formed using a phase shift technology. In the phase shift mask (PSM), various features in the pattern formed on the mask are configured to have proper phase difference to enhance the resolution and imaging quality. In various examples, the phase shift mask is an attenuated PSM or alternating PSM. The mask(s) generated by mask fabrication 834 is used in a variety of processes. For example, such a mask(s) is used in an ion implantation process to form various doped regions in the semiconductor wafer, in an etching process to form various etching regions in the semiconductor wafer, and/or in other suitable processes.

IC fab 850 is an IC fabrication business that includes one or more manufacturing facilities for the fabrication of a variety of different IC products. In some embodiments, IC fab 850 is a semiconductor foundry. For example, there may be a manufacturing facility for the front end fabrication of a plurality of IC products (front-end-of-line (FEOL) fabrication), while a second manufacturing facility may supply the back end fabrication for the interconnection and packaging of the IC products (back-end-of-line (BEOL) fabrication), and a third manufacturing facility may supply other services for the foundry business.

IC fab 850 uses the mask (or masks) fabricated by mask house 830 to fabricate IC device 860 using fabrication tools 852. Thus, IC fab 850 at least indirectly uses IC design layout 822 to fabricate IC device 860. In some embodiments, a semiconductor wafer 853 is fabricated by IC fab 850 using the mask (or masks) to form IC device 860. Semiconductor wafer 853 includes a silicon substrate or other proper substrate having material layers formed thereon. Semiconductor wafer further includes one or more of various doped regions, dielectric features, multilevel interconnects, and the like (formed at subsequent manufacturing steps).

In some embodiments, a method (of manufacturing a semiconductor device for which a corresponding layout diagram includes instantiated cells, each instantiated cell being an instantiation of a corresponding standard cell selected from a standard-cell-library of standard cells, the layout diagram, the standard-cell-library and the first performance-data-library being stored on a non-transitory computer-readable medium) includes generating the first performance-data-library including: for each standard cell that includes multiple gates, sorting the gates into groups including: searching for matched ones amongst the gates (matched gates); grouping corresponding matched gates into corresponding first groups, each first group having multiple member-gates; and for unmatched ones of the gates having no other matched gate (unmatched gates), grouping the unmatched gates into corresponding second groups, each second group having a corresponding single member-gate; for each standard cell, generating a corresponding first volume of performance data on which are based attributes of the standard cell including: for each first group thereof: for a subject one of the member-gates in the first group (first subject gate), discretely calculating the first volume of performance data; mapping the volume of performance data to the first subject gate; and mapping the volume of performance data to remaining ones of the member-gates in the first group (non-subject gates); for each second group thereof: for a subject one of the member-gates in the second group (second subject gate), determining the first volume of performance data; and mapping the first volume of performance data to the second subject gate; and basing a first performance-data-library at least in part on the first volumes of performance data, attributes of the standard cells of the standard-cell-library being based on the first performance-data-library.

In some embodiments, the sorting the gates into groups further includes: before the searching for matched ones amongst the gates (matched gates), setting a status of each gate to be unsorted (unsorted status); the searching for matched ones amongst the gates (matched gates) includes: for a target one of the gates (target gate) relative to which other ones of the gates are non-target gates, comparing a description of the target gate to descriptions correspondingly of the non-target gates to recognize which one or more of the non-target gates matches the target gate (recognized gates); deeming the target gate and the recognized gates to be matching gates; and setting the status of the target gate and the recognized gates to be sorted; and, for remaining gates having the unsorted status, iterating the searching for matched ones amongst the gates (matched gates).

In some embodiments, each description includes a logical function of the corresponding gate.

In some embodiments, each description includes a count of input pins of the corresponding gate.

In some embodiments, each description includes a logical description of each input pin of the corresponding gate.

In some embodiments, each gate has N inputs, where N is a positive integer and N is equal to or greater than 2; the generating a corresponding first volume of performance data further includes: for each subject gate of each first group and of each second group: for each of 2\hat{ }N combinations of values for the N inputs, determining corresponding 2\hat{ }N pages of performance data based on: the corresponding Nth combination of values for the N inputs of the subject gate; and a predefined combination of values for the N inputs of each of the non-subject gates; each first volume of performance data is a set that includes the corresponding 2\hat{ }N pages of performance data.

In some embodiments, the performance data is a timing arc representing an elapsed time during which the subject gate generates a corresponding stable output value.

In some embodiments, in a context of the subject gate being a flip-flop, the elapsed time represented by the timing arc is from an active edge of a clock signal until the subject gate generates the corresponding stable output value.

In some embodiments, the performance data is a power arc representing an amount of power consumed while the subject gate generates a corresponding stable output value.

In some embodiments, the performance data is a setup-time arc representing a minimum elapsed time that output data must be held stable by the subject gate before a next active clock edge.

In some embodiments, the performance data is a hold-time arc representing a minimum elapsed time that inputs to the subject gate must be held stable after an active clock edge.

In some embodiments, in a context of the subject gate being a flip-flop, the performance data is a recovery-time arc representing a minimum permissible elapsed time from de-assertion of a reset signal to a next active clock edge required by the subject gate.

In some embodiments, in a context of the gate being a flip-flop, the performance data is a removal-time arc representing a minimum permissible elapsed time after a next active clock edge before which a reset signal is de-asserted by the subject gate.

In some embodiments, in a context of the gate being a flip-flop, the performance data is a clear-time arc representing a minimum elapsed time after a clear pin is activated for the subject gate to generate a stable logical low output value.

In some embodiments, in a context of the gate being a flip-flop, the performance data is a preset-time arc representing a minimum elapsed time after a preset pin is activated for the subject gate to generate a stable logical high output value.

In some embodiments, the determining the first volume of performance data includes: discretely calculating the first volume of performance data.

In some embodiments, the method further includes: generating the layout diagram; and, based on the layout diagram, at least one of: (A) making one or more photolithographic exposures; (B) fabricating one or semiconductor devices; or (C) fabricating at least one component in a layer of a semiconductor integrated circuit.

In some embodiments, a system for manufacturing a semiconductor device, the system including at least one processor, at least one non-transitory computer readable medium that stores computer executable code; a corresponding layout diagram including instantiated cells, each instantiated cell being an instantiation of a corresponding standard cell selected from a standard-cell-library of standard cells, the layout diagram, the standard-cell-library and the first performance-data-library being stored on a non-transitory computer-readable medium, the non-transitory computer readable storage medium, the computer program code and the at least one processor being configured to cause the system to generate the first performance-data-library including: for each standard cell that includes multiple gates, sorting features of the gates into groups including: searching for matched ones amongst the features of the gates (matched features); grouping corresponding matched features into corresponding first groups, each first group having multiple member-features; and for unmatched ones of the features having no other matched feature (unmatched features), grouping the unmatched features into corresponding second groups, each second group having a corresponding single member-features; for each standard cell, generating a corresponding first volume of performance data on which are based attributes of the standard cell including: for each first group thereof: for a subject one of the member-features in the first group (first subject feature), discretely calculating the first volume of performance data; mapping the volume of performance data to the first subject feature; and mapping the volume of performance data to remaining ones of the member-features in the first group (non-subject features); for each second group thereof: for a subject one of the member-features in the second group (second subject feature), determining the first volume of performance data; and mapping the first volume of performance data to the second subject feature; and basing the first performance-data-library at least in part on the first volumes of performance data, attributes of the standard cells of the standard-cell-library being based on the first performance-data-library.

In some embodiments, the system further includes: at least one of: a masking facility configured to fabricate one or more semiconductor masks based on based on the layout diagram; or a fabricating facility configured to fabricate at least one component in a layer of a semiconductor integrated circuit based on the layout diagram.

In some embodiments, a non-transitory computer-readable medium having stored thereon computer executable instructions representing a method (of generating a first performance-data-library, attributes of standard cells that comprise a standard cell library being based on the first performance-data library, the standard-cell-library and the first performance-data-library being stored on a non-transitory computer-readable medium) the computer executable instructions being executable by at least one processor to perform the method including: for each standard cell that includes multiple gates, each gate having N inputs, where N is a positive integer and N is equal to or greater than 2, sorting the gates into groups including: searching for matched ones amongst the gates (matched gates); grouping corresponding matched gates into corresponding first groups, each first group having multiple member-gates; and for unmatched ones of the gates having no other matched gate (unmatched gates), grouping the unmatched gates into corresponding second groups, each second group having a corresponding single member-gate; for each standard cell, generating a corresponding first volume of performance data on which are based attributes of the standard cell including: for each first group thereof: for a subject one of the member-gates in the first group (first subject gate), discretely calculating the first volume of performance data; mapping the volume of performance data to the first subject gate; and mapping the volume of performance data to remaining ones of the member-gates in the first group (non-subject gates); for each second group thereof: for a subject one of the member-gates in the second group (second subject gate), determining the first volume of performance data; and mapping the first volume of performance data to the second subject gate; and basing the first performance-data-library at least in part on the first volumes of performance data; the generating a corresponding first volume of performance data further including: for each subject gate of each first group and of each second group: for each of 2\hat{ }N combinations of values for the N inputs, determining corresponding 2\hat{ }N pages of performance data based on: the corresponding Nth combination of values for the N inputs of the subject gate; and a predefined combination of values for the N inputs of each of the non-subject gates; and each first volume of performance data being a set that includes the corresponding 2\hat{ }N pages of performance data.

In some embodiments, the determining the first volume of performance data includes discretely calculating the first volume of performance data.

It will be readily seen by one of ordinary skill in the art that one or more of the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A method of manufacturing a semiconductor device for which a corresponding layout diagram includes instantiated cells, each instantiated cell being an instantiation of a corresponding standard cell selected from a standard-cell-library of standard cells, the layout diagram, the standard-cell-library and the first performance-data-library being stored on a non-transitory computer-readable medium, the method comprising generating the first performance-data-library including:
for each standard cell that includes multiple gates, sorting the gates into groups including:
searching for matched ones amongst the gates (matched gates);
grouping corresponding matched gates into corresponding first groups, each first group having multiple member-gates; and
for unmatched ones of the gates having no other matched gate (unmatched gates), grouping the unmatched gates into corresponding second groups, each second group having a corresponding single member-gate;
for each standard cell, generating a corresponding first volume of performance data on which are based attributes of the standard cell including:
for each first group thereof:
for a subject one of the member-gates in the first group (first subject gate), discretely calculating the first volume of performance data;
mapping the volume of performance data to the first subject gate; and
mapping the volume of performance data to remaining ones of the member-gates in the first group (non-subject gates);
for each second group thereof:
for a subject one of the member-gates in the second group (second subject gate), determining the first volume of performance data; and
mapping the first volume of performance data to the second subject gate; and
basing a first performance-data-library at least in part on the first volumes of performance data, attributes of the standard cells of the standard-cell-library being based on the first performance-data-library informing correspondingly.

2. The method of claim 1, wherein:
the sorting the gates into groups further includes:
before the searching for matched ones amongst the gates (matched gates), setting a status of each gate to be unsorted (unsorted status);
the searching for matched ones amongst the gates (matched gates) includes:
for a target one of the gates (target gate) relative to which other ones of the gates are non-target gates, comparing a description of the target gate to descriptions correspondingly of the non-target gates to recognize which one or more of the non-target gates matches the target gate (recognized gates);
deeming the target gate and the recognized gates to be matching gates; and
setting the status of the target gate and the recognized gates to be sorted; and
for remaining gates having the unsorted status, iterating the searching for matched ones amongst the gates (matched gates).

3. The method of claim 2, wherein each description includes:
a logical function of the corresponding gate.

4. The method of claim 3, wherein each description includes:
a count of input pins of the corresponding gate.

5. The method of claim 2, wherein each description includes:
a logical description of each input pin of the corresponding gate.

6. The method of claim 1, wherein:
each gate has N inputs, where N is a positive integer and N is equal to or greater than 2;
the generating a corresponding first volume of performance data further includes:
for each subject gate of each first group and of each second group:
for each of 2\hat{ }N combinations of values for the N inputs, determining corresponding 2\hat{ }N pages of performance data based on:
the corresponding Nth combination of values for the N inputs of the subject gate; and
a predefined combination of values for the N inputs of each of the non-subject gates;
each first volume of performance data is a set that includes the corresponding 2\hat{ }N pages of performance data.

7. The method of claim 1, wherein:
the performance data is a timing arc representing an elapsed time during which the subject gate generates a corresponding stable output value.

8. The method of claim 7, wherein:
in a context of the subject gate being a flip-flop, the elapsed time represented by the timing arc is from an active edge of a clock signal until the subject gate generates the corresponding stable output value.

9. The method of claim 1, wherein:
the performance data is a power arc representing an amount of power consumed while the subject gate generates a corresponding stable output value.

10. The method of claim 1, wherein:
the performance data is a setup-time arc representing a minimum elapsed time that output data must be held stable by the subject gate before a next active clock edge.

11. The method of claim 1, wherein:
the performance data is a hold-time arc representing a minimum elapsed time that inputs to the subject gate must be held stable after an active clock edge.

12. The method of claim 1, wherein:
in a context of the subject gate being a flip-flop, the performance data is a recovery-time arc representing a minimum permissible elapsed time from de-assertion of a reset signal to a next active clock edge required by the subject gate.

13. The method of claim 1, wherein:
in a context of the gate being a flip-flop, the performance data is a removal-time arc representing a minimum permissible elapsed time after a next active clock edge before which a reset signal is de-asserted by the subject gate.

14. The method of claim 1, wherein:
in a context of the gate being a flip-flop, the performance data is a clear-time arc representing a minimum elapsed time after a clear pin is activated for the subject gate to generate a stable logical low output value.

15. The method of claim 1, wherein:
in a context of the gate being a flip-flop, the performance data is a preset-time arc representing a minimum elapsed time after a preset pin is activated for the subject gate to generate a stable logical high output value.

16. The method of claim 1, further comprising:
generating the layout diagram; and
based on the layout diagram, at least one of:
(A) making one or more photolithographic exposures;
(B) fabricating one or semiconductor devices; or
(C) fabricating at least one component in a layer of a semiconductor integrated circuit.

17. A system for manufacturing a semiconductor device, the system comprising:
at least one processor;
at least one non-transitory computer readable medium that stores computer executable code;
a corresponding layout diagram including instantiated cells, each instantiated cell being an instantiation of a corresponding standard cell selected from a standard-cell-library of standard cells, the layout diagram, the standard-cell-library and the first performance-data-library being stored on a non-transitory computer-readable medium,
the non-transitory computer readable storage medium, the computer program code and the at least one processor being configured to cause the system to generate the first performance-data-library including:
for each standard cell that includes multiple gates, sorting features of the gates into groups including:
searching for matched ones amongst the features of the gates (matched features);
grouping corresponding matched features into corresponding first groups, each first group having multiple member-features; and
for unmatched ones of the features having no other matched feature (unmatched features), grouping the unmatched features into corresponding second groups, each second group having a corresponding single member-features;
for each standard cell, generating a corresponding first volume of performance data on which are based attributes of the standard cell including:
for each first group thereof:
for a subject one of the member-features in the first group (first subject feature), discretely calculating the first volume of performance data;
mapping the volume of performance data to the first subject feature; and
mapping the volume of performance data to remaining ones of the member-features in the first group (non-subject features);
for each second group thereof:
for a subject one of the member-features in the second group (second subject feature), determining the first volume of performance data; and
mapping the first volume of performance data to the second subject feature; and
basing the first performance-data-library at least in part on the first volumes of performance data, attributes of the standard cells of the standard-cell-library being based on the first performance-data-library.

18. The system of claim 17, further comprising at least one of:
a masking facility configured to fabricate one or more semiconductor masks based on based on the layout diagram; or
a fabricating facility configured to fabricate at least one component in a layer of a semiconductor integrated circuit based on the layout diagram.

19. A non-transitory computer-readable medium having stored thereon computer executable instructions representing a method of generating a first performance-data-library, attributes of standard cells that comprise a standard cell library being based on the first performance-data library, the standard-cell-library and the first performance-data-library being stored on a non-transitory computer-readable medium, the computer executable instructions being executable by at least one processor to perform the method including:
for each standard cell that includes multiple gates, each gate having N inputs, where N is a positive integer and N is equal to or greater than 2, sorting the gates into groups including:
searching for matched ones amongst the gates (matched gates);
grouping corresponding matched gates into corresponding first groups, each first group having multiple member-gates; and
for unmatched ones of the gates having no other matched gate (unmatched gates), grouping the unmatched gates into corresponding second groups, each second group having a corresponding single member-gate;
for each standard cell, generating a corresponding first volume of performance data on which are based attributes of the standard cell including:
for each first group thereof:
for a subject one of the member-gates in the first group (first subject gate), discretely calculating the first volume of performance data;
mapping the volume of performance data to the first subject gate; and
mapping the volume of performance data to remaining ones of the member-gates in the first group (non-subject gates);
for each second group thereof:
for a subject one of the member-gates in the second group (second subject gate), determining the first volume of performance data; and
mapping the first volume of performance data to the second subject gate; and
basing the first performance-data-library at least in part on the first volumes of performance data;
the generating a corresponding first volume of performance data further including:
for each subject gate of each first group and of each second group:
for each of 2\hat{ }N combinations of values for the N inputs, determining corresponding 2\hat{ }N pages of performance data based on:
the corresponding Nth combination of values for the N inputs of the subject gate; and
a predefined combination of values for the N inputs of each of the non-subject gates; and
each first volume of performance data being a set that includes the corresponding 2\hat{ }N pages of performance data.

20. The non-transitory computer-readable medium claim 19, wherein the determining the first volume of performance data includes:
discretely calculating the first volume of performance data.
